(19) United States
(12) Patent Application Publication
(10) Pub. No.: US 2015/0117514 A1
(43) Pub. Date: Apr. 30, 2015

(54) THREE-DIMENSIONAL VIDEO ENCODING METHOD USING SLICE HEADER AND METHOD THEREFOR, AND THREE-DIMENSIONAL VIDEO DECODING METHOD AND DEVICE THEREFOR

(71) Applicant: SUMSUNG ELECTRONICS CO., LTD., Suwon-si (KR)

(72) Inventors: Byeong-doo Choi, Siheung-si (KR); Jae-hyun Kim, Seoul (KR); Jeong-hoon Park, Seoul (KR)

(73) Assignee: SAMSUNG ELECTRONICS CO., LTD., Suwon-si (KR)

(21) Appl. No.: 14/396,581

(22) PCT Filed: Apr. 23, 2013
(86) PCT No.: PCT/KR2013/003460

§ 371 Date: Oct. 23, 2014

Related U.S. Application Data
(60) Provisional application No. 61/636,973, filed on Apr. 23, 2012.

(51) Int. Cl. H04N 13/00

(52) U.S. Cl. CPC H04N 13/0048
USPC 375/240.01

(57) ABSTRACT

A 3D video encoding method includes determining whether a current slice is a depth image from among a texture image and the depth image, the texture image and the depth image being part of a 3D image of a same view and being encoded prior to the current slice; when the determining indicates that the current slice is the depth image, determining whether to encode the depth image by using the texture image; when the determining indicates that the current slice is the texture image, determining whether to encode the texture image by using the depth image; and encoding the texture image and the depth image based on a relationship between the texture image and the depth image, determined based on the determining of whether to encode the depth image by using the texture image and to encode the texture image by using the depth image.

### CROSS-REFERENCE TO RELATED APPLICATIONS

This application is a National Stage Entry of PCT/KR2013/003460, filed on Apr. 23, 2013, which claims priority to U.S. provisional patent application No. 61/636,973, filed on Apr. 23, 2012 in the U.S. Patent and Trademark Office, the entire disclosures of which are incorporated herein by reference in their entirety.

### TECHNICAL FIELD

The exemplary embodiments relate to 3-dimensional (3D) video encoding for separating and encoding a single-view image into a texture image and a depth image and 3D video decoding for separating and decoding a single-view image into a texture image and a depth image.

### BACKGROUND OF THE RELATED ART

As hardware for reproducing and storing high resolution or high quality video content is being developed and supplied, the need for a video codec for effectively encoding or decoding the high resolution or high quality video content is increasing. According to a conventional video codec, a video is encoded according to a limited encoding method based on a macroblock having a predetermined size.

Image data of a spatial region is transformed into coefficients of a frequency region via frequency transformation. According to a video codec, an image is split into blocks having a predetermined size, discrete cosine transformation (DCT) is performed for each respective block, and frequency coefficients are encoded in block units, for rapid calculation for frequency transformation. Compared with image data of a spatial region, coefficients of a frequency region are easily compressed. In particular, since an image pixel value of a spatial region is expressed according to a prediction error via inter prediction or intra prediction of a video codec, when frequency transformation is performed on the prediction error, a large amount of data may be transformed to 0. According to a video codec, an amount of data may be reduced by replacing data that is consecutively and repeatedly generated with small-sized data.

While there is an increasing demand for video captured from various viewpoints, an amount of data of a video that increases by as much as the number of views is problematic. Accordingly, efforts to effectively encode multi-view video are being continuously made.

### SUMMARY

The exemplary embodiments provide methods of prediction encoding and decoding a texture image and a depth image of a single-view image of 3-dimensional (3D) video.

According to an aspect of an exemplary embodiment, there is provided a 3-dimensional (3D) video encoding method including: determining whether a current slice is a depth image from among a texture image and the depth image, the texture image and the depth image being part of a 3D image of a same view and being encoded prior to the current slice; when the determining indicates that the current slice is the depth image, determining whether to encode the depth image by using the texture image; when the determining indicates that the current slice is the texture image, determining whether to encode the texture image by using the depth image; and encoding the texture image and the depth image based on a relationship between the texture image and the depth image, the relationship being determined based on the determining of whether to encode the depth image by using the texture image and the determining of whether to encode the texture image by using the depth image.

The encoding may include: when the current slice is the depth image, encoding the depth image by using the texture image, and the 3D video encoding method may further include: generating a slice header including first information indicating that the current slice is the depth image and second information indicating that the depth image is encoded by using the texture image.

The encoding may further include: when the current slice is the texture image, encoding the texture image by using the depth image, and the 3D video encoding method may further include: generating a slice header including first information indicating that the current slice is not the depth image and third information indicating that the texture image is encoded by using the depth image.

When the current slice is the depth image, the determining of whether to encode the depth image may include: determining whether to determine slice related information of the depth image by referring to slice related information of the texture image, and the encoding may include: encoding the depth image by using the slice related information of the texture image, and the generating of the slice header may include: when the current slice is the depth image, generating the slice header further including fourth information indicating whether to determine the slice related information of the depth image by referring to the slice related information of the texture image.

The generating of the slice header may further include: if the fourth information indicates that the slice related information of the texture image is not referred to when determining the slice related information of the depth image, generating the slice header to further include at least one among information indicating a decoded picture buffer (DPB) state of a reference picture selection (RPS) of the depth image, a reference index, and a slice quantization parameter (QP) differential value.

The encoding may further include: among maximum coding units spatially split from the texture image and the depth image, splitting each of the maximum coding units into a plurality of coding units, and determining whether to split each of the plurality of coding units into smaller coding units independently from adjacent coding units among the plurality of coding units; and outputting encoding information that is determined from a coding unit that is no longer split among the plurality of coding units.

According to another aspect of an exemplary embodiment, there is provided a 3D video decoding method including: determining whether a current slice is a depth image from among a texture image and the depth image, the texture image and the depth image being part of a 3D image of a same view and being encoded prior to the current slice; when the determining indicates that the current slice is the depth image, determining whether to decode the depth image by using the texture image; when the determining indicates that the current slice is the texture image, determining whether to decode the texture image by using the depth image; and decoding the texture image and the depth image based on a relationship between the texture image and the depth image, the relationship being determined based on the determining of whether to decode the depth image by using the texture image and the determining of whether to decode the texture image by using the depth image.

The 3D video decoding method may further include parsing first information indicating that the current slice is the depth image and second information indicating that the depth image is decoded by using the texture image from a slice header for the current slice, and the decoding may further include: when the current slice is read as the depth image based on the first information, decoding the depth image by using the texture image.

The 3D video decoding method may further include parsing first information indicating that the current slice is not the depth image and third information indicating that the texture image is decoded by using the depth image, and the decoding may include: when the current slice is read as the texture image, decoding the texture image by using the depth image.

When the current slice is read as the depth image based on the first information, the parsing of the second information may include: parsing fourth information indicating whether to determine slice related information of the depth image by referring to slice related information of the texture image from the slice header, and the determining of whether to decode the depth image may include: determining whether to determine the slice related information of the depth image by referring to the slice related information of the texture image based on the fourth information, and the decoding may include: decoding the depth image by using the slice related information of the texture image according to a determination based on the fourth information.

The decoding may further include: if the fourth information indicates that the slice related information of the texture image is not referred to when determining the slice related information of the depth image, parsing further at least one among information indicating a decoded picture buffer (DPB) state of a reference picture selection (RPS) of the depth image, a reference index, and a slice quantization parameter (QP) differential value from the slice header.

The decoding may further include: among maximum coding units spatially split from the texture image and the depth image, splitting each of the maximum coding units into a plurality of coding units, and determining whether to split each of the plurality of coding units into smaller coding units independently from adjacent coding units among the plurality of coding units; and decoding a coding unit that is no longer split among the plurality of coding units by using encoding information that is determined from the coding unit.

According to another aspect of an exemplary embodiment, there is provided a 3D video encoding apparatus including: a 3D image reference determiner configured to determine whether a current slice is a depth image from among a texture image and the depth image, the texture image and the depth image being part of a 3D image of a same view and being encoded prior to the current slice, and, when the 3D image reference determiner determines that the current slice is the depth image, the 3D image reference determiner may be further configured to determine whether to encode the depth image by using the texture image, and, when the 3D image reference determiner determines that the current slice is the texture image, the 3D image reference determiner may be further configured to determine whether to encode the texture image by using the depth image; and an encoder configured to encode the texture image and the depth image based on a relationship between the texture image and depth image, the relationship being determined based on the determination of whether to encode the depth image by using the texture image and the determination of whether to encode the texture image by using the depth image.

According to another aspect of an exemplary embodiment, there is provided a 3D video decoding apparatus including: a 3D image reference parser configured to determine whether a current slice is a depth image from among a texture image and the depth image, the texture image and the depth image being part of a 3D image of a same view and being encoded prior to the current slice, from information parsed from a slice header, and, when the 3D image reference parser determines that the current slice is the depth image, the 3D image reference parser may be further configured to determine whether to decode the depth image by using the texture image, and, when the 3D image reference parser determines that the current slice is the texture image, the 3D image reference parser may be further configured to determine whether to decode the texture image by using the depth image; and a decoder configured to decode the texture image and the depth image based on a relationship between the texture image and depth image, the relationship being determined based on the determination of whether to decode the depth image by using the texture image and the determination of whether to decode the texture image by using the depth image.

According to another aspect of an exemplary embodiment, there is provided a non-transitory computer readable recording medium having recorded thereon a program for executing the 3D video encoding method according to an aspect of an exemplary embodiment.

According to another aspect of an exemplary embodiment, there is provided a non-transitory computer readable recording medium having recorded thereon a program for executing the 3D video decoding method according to another aspect of an exemplary embodiment.

When a texture image and a depth image of the same view are encoded by being referred to each other, 3-dimensional (3D) image reference information indicating whether a current slice is a depth image referring to a previously decoded texture image or a texture image referring to a previously decoded depth image may be recorded on a slice header according to the exemplary embodiments. Accordingly, the slice header may be used to exactly determine a reference relationship between the texture image and the depth image of the same view in the current slice, thereby efficiently decoding the texture image and the depth image.

In particular, when a texture image and a depth image of one view are encoded by being referred to each other, redundant information between a slice header of the depth image and a slice header of the texture image is omitted in the slice header of the depth image, thereby reducing a transmission rate to achieve a reduction in the slice header and reducing a parsing process for reading the slice header.

### BRIEF DESCRIPTION OF THE DRAWINGS

FIG. 1 is a block diagram of a video encoding apparatus based on coding units having a tree structure according to an exemplary embodiment;

FIG. 2 is a block diagram of a video decoding apparatus based on coding units having a tree structure according to an exemplary embodiment;

FIG. 3 is a diagram for describing a concept of coding units according to an exemplary embodiment;

FIG. 4 is a block diagram of an image encoder based on coding units according to an exemplary embodiment;

FIG. 5 is a block diagram of an image decoder based on coding units according to an exemplary embodiment;

FIG. 6 is a diagram illustrating deeper coding units according to depths, and partitions according to an exemplary embodiment;

FIG. 7 is a diagram for describing a relationship between a coding unit and transformation units, according to an exemplary embodiment;

FIG. 8 is a diagram for describing encoding information of coding units corresponding to a coded depth, according to an exemplary embodiment;

FIG. 9 is a diagram of deeper coding units according to depths, according to an exemplary embodiment;

FIGS. 10, 11 and 12 are diagrams for describing a relationship between coding units, prediction units, and transformation units, according to an exemplary embodiment;

FIG. 13 is a diagram for describing a relationship between a coding unit, a prediction unit or a partition, and a transformation unit, according to encoding mode information of Table 1;

FIG. 14 is a block diagram of a 3-dimensional (3D) encoding system using inter-layer prediction according to an exemplary embodiment;

FIG. 15A is a block diagram of a 3D video encoding apparatus according to an exemplary embodiment;

FIG. 15B is a flowchart of a 3D video encoding method according to an exemplary embodiment;

FIG. 16A is a block diagram of a 3D video decoding apparatus according to an exemplary embodiment;

FIG. 16B is a flowchart of a 3D video decoding method according to an exemplary embodiment;

FIG. 17 shows a syntax of a slice header according to an exemplary embodiment;

FIG. 18 illustrates a physical structure of a disc that stores a program, according to an exemplary embodiment;

FIG. 19 illustrates a disc drive that records and reads a program by using a disc;

FIG. 20 illustrates a structure of a content supply system that provides a content distribution service;

FIGS. 21 and 22 illustrate external and internal structures of a mobile phone to which a video encoding method and a video decoding method are applied, according to an exemplary embodiment;

FIG. 23 illustrates a digital broadcasting system employing a communication system, according to an exemplary embodiment; and

FIG. 24 illustrates a network structure of a cloud computing system using a video encoding apparatus and a video decoding apparatus, according to an exemplary embodiment.

### DETAILED DESCRIPTION OF THE EXEMPLARY EMBODIMENTS

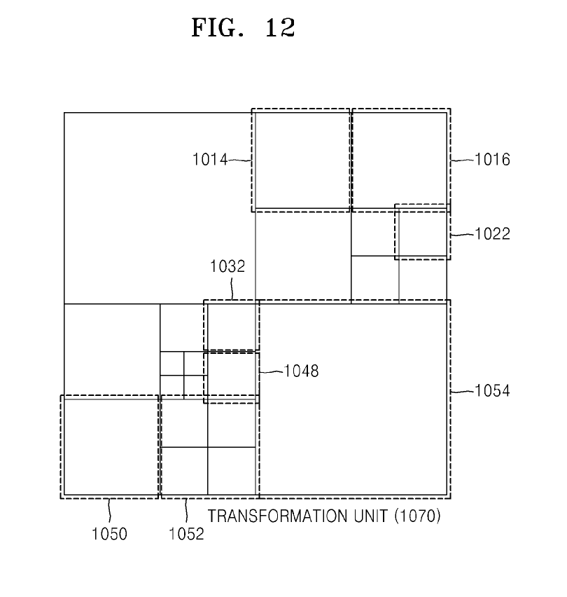

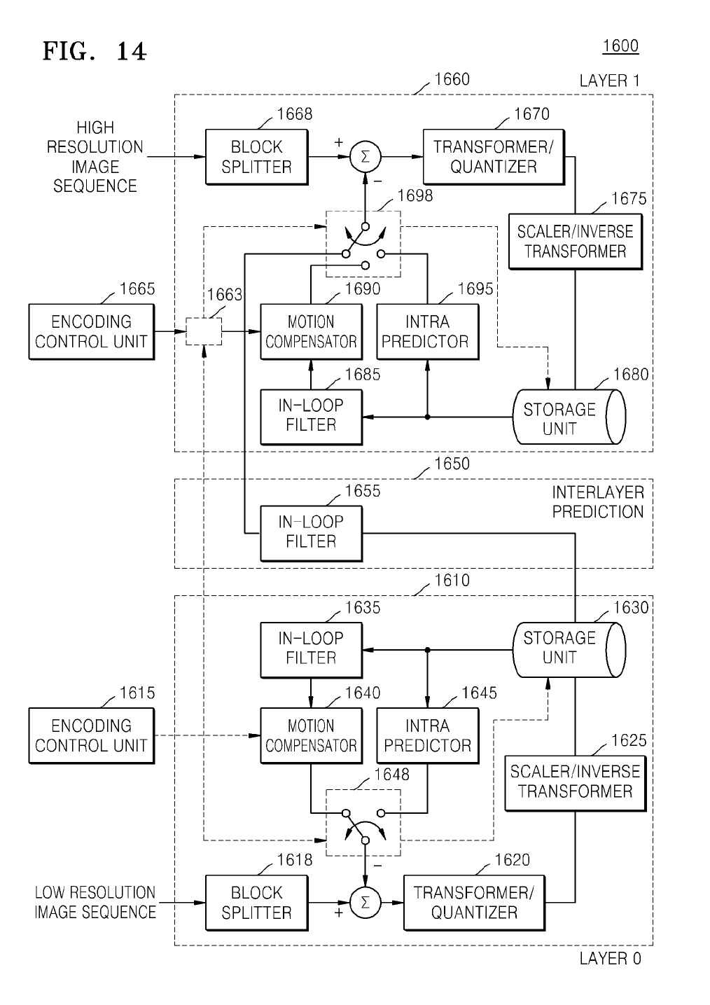

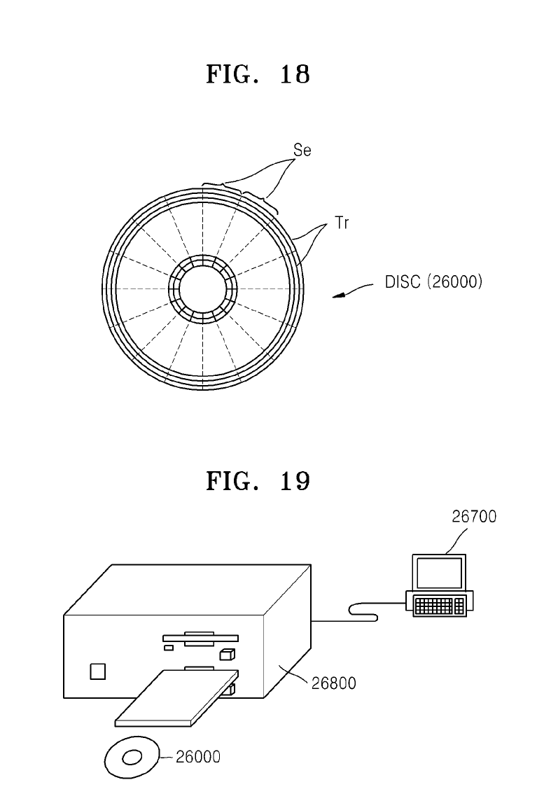

Hereinafter, a video encoding method and a video decoding method based on coding units having a tree structure according to an exemplary embodiment will be described with reference to FIGS. 1 through 13. A 3-dimensional (3D) video encoding method and a 3D video decoding method according to an exemplary embodiment will also be described with reference to FIGS. 14 through 17. A 3D video encoding method and a 3D video decoding method according to an exemplary embodiment will also be described with reference to FIGS. 18 through 24. Hereinafter, the term “image” may refer to a still image or a moving picture, that is, a video.

The video encoding method and the video decoding method based on coding units having the tree structure will now be described with reference to FIGS. 1 through 13.

FIG. 1 is a block diagram of a video encoding apparatus 100 based on a coding unit according to a tree structure, according to an exemplary embodiment.

The video encoding apparatus 100, which is configured to perform an encoding operation based on video prediction based on the coding unit according to the tree structure according to an exemplary embodiment, includes a maximum coding unit (MCU) splitter 110, a coding unit determiner 120, and an output unit 130 (e.g., outputter). Hereinafter, for convenience of description, the video encoding apparatus 100, which is configured to perform an encoding operation based on video prediction based on the coding unit according to the tree structure according to an exemplary embodiment, is referred to as “the video encoding apparatus 100”.

The maximum coding unit splitter 110 may split a current picture based on a maximum coding unit for the current picture of an image. If the current picture is larger than the maximum coding unit, image data of the current picture may be split into the at least one maximum coding unit. The maximum coding unit according to an exemplary embodiment may be a data unit having a size of 32×32, 64×64, 128×128, 256×256, etc., wherein a shape of the data unit is a square having a width and length in squares of 2. The image data may be output to the coding unit determiner 120 according to the at least one maximum coding unit.

A coding unit according to an exemplary embodiment may be characterized by a maximum size and a depth. The depth denotes a number of times the coding unit is spatially split from the maximum coding unit, and as the depth deepens, deeper encoding units according to depths may be split from the maximum coding unit to a minimum coding unit. A depth of the maximum coding unit is an uppermost depth and a depth of the minimum coding unit is a lowermost depth. Since a size of a coding unit corresponding to each depth decreases as the depth of the maximum coding unit deepens, a coding unit corresponding to an upper depth may include a plurality of coding units corresponding to lower depths.

As described above, the image data of the current picture is split into the maximum coding units according to a maximum size of the coding unit, and each of the maximum coding units may include deeper coding units that are split according to depths. Since the maximum coding unit according to an exemplary embodiment is split according to depths, the image data of a spatial domain included in the maximum coding unit may be hierarchically classified according to depths.

A maximum depth and a maximum size of a coding unit, which limit the total number of times a height and a width of the maximum coding unit are hierarchically split, may be predetermined.

The coding unit determiner 120 encodes at least one split region obtained by splitting a region of the maximum coding unit according to depths, and determines a depth to output finally encoded image data according to the at least one split region. In other words, the coding unit determiner 120 determines a coded depth by encoding the image data in the deeper coding units according to depths, according to the maximum coding unit of the current picture, and selecting a depth having the least encoding error. Thus, the encoded image data of the coding unit corresponding to the determined coded depth is finally output. Also, the coding units corresponding to the coded depth may be regarded as encoded coding units. The determined coded depth and the encoded image data according to the determined coded depth are output to the output unit 130.

The image data in the maximum coding unit is encoded based on the deeper coding units corresponding to at least one depth equal to or below the maximum depth, and results of encoding the image data are compared based on each of the deeper coding units. A depth having the least encoding error may be selected after comparing encoding errors of the deeper coding units. At least one coded depth may be selected for each maximum coding unit.

The size of the maximum coding unit is split as a coding unit is hierarchically split according to depths, and as the number of coding units increases. Also, even if coding units correspond to the same depth in one maximum coding unit, it is determined whether to split each of the coding units corresponding to the same depth to a lower depth by measuring an encoding error of the image data of each coding unit, separately. Accordingly, even when image data is included in one maximum coding unit, the image data is split into regions according to the depths and the encoding errors may differ according to regions in the one maximum coding unit, and thus, the coded depths may differ according to regions in the image data. Thus, one or more coded depths may be determined in one maximum coding unit, and the image data of the maximum coding unit may be divided according to coding units of at least one coded depth.

Accordingly, the coding unit determiner 120 may determine coding units having a tree structure included in the maximum coding unit. The ‘coding units having a tree structure’ according to an exemplary embodiment include coding units corresponding to a depth determined to be the coded depth, from among all deeper coding units included in the maximum coding unit. A coding unit of a coded depth may be hierarchically determined according to depths in the same region of the maximum coding unit, and may be independently determined in different regions. Similarly, a coded depth in a current region may be independently determined from a coded depth in another region.

A maximum depth according to an exemplary embodiment is an index related to the number of times splitting is performed from a maximum coding unit to a minimum coding unit. A first maximum depth according to an exemplary embodiment may denote the total number of times splitting is performed from the maximum coding unit to the minimum coding unit. A second maximum depth according to an exemplary embodiment may denote the total number of depth levels from the maximum coding unit to the minimum coding unit. For example, when a depth of the maximum coding unit is 0, a depth of a coding unit, in which the maximum coding unit is split once, may be set to 1, and a depth of a coding unit, in which the maximum coding unit is split twice, may be set to 2. Here, if the minimum coding unit is a coding unit in which the maximum coding unit is split four times, 5 depth levels of depths 0, 1, 2, 3 and 4 exist, and thus the first maximum depth may be set to 4, and the second maximum depth may be set to 5.

Prediction encoding and transformation may be performed according to the maximum coding unit. The prediction encoding and the transformation are also performed based on the deeper coding units according to a depth equal to or depths less than the maximum depth, according to the maximum coding unit. Transformation may be performed according to a method of orthogonal transformation or integer transformation.

Since the number of deeper coding units increases whenever the maximum coding unit is split according to depths, encoding including the prediction encoding and the transformation is performed on all of the deeper coding units generated as the depth deepens. For convenience of description, the prediction encoding and the transformation will now be described based on a coding unit of a current depth, in a maximum coding unit.

The video encoding apparatus 100 may variously select a size or shape of a data unit for encoding the image data. In order to encode the image data, operations, such as prediction encoding, transformation, and entropy encoding, are performed, and at this time, the same data unit may be used for all operations or different data units may be used for each operation.

For example, the video encoding apparatus 100 may select not only a coding unit for encoding the image data, but also a data unit different from the coding unit so as to perform the prediction encoding on the image data in the coding unit.

In order to perform prediction encoding on the maximum coding unit, the prediction encoding may be performed based on a coding unit corresponding to a coded depth, e.g., based on a coding unit that is no longer split into coding units corresponding to a lower depth. Hereinafter, the coding unit that is no longer split and becomes a basis unit for prediction encoding will now be referred to as a ‘prediction unit’. A partition obtained by splitting the prediction unit may include a prediction unit or a data unit obtained by splitting at least one of a height and a width of the prediction unit. The partition is a data unit obtained by dividing the prediction unit of the coding unit and the prediction unit may be a partition having the same size as the coding unit.

For example, when a coding unit of 2N×2N (where N is a positive integer) is no longer split and becomes a prediction unit of 2N×2N, a size of a partition may be 2N×2N, 2N×N, N×2N, or N×N. Examples of a partition type include symmetrical partitions that are obtained by symmetrically splitting a height or width of the prediction unit, partitions obtained by asymmetrically splitting the height or width of the prediction unit, such as 1:n or n:1, partitions that are obtained by geometrically splitting the prediction unit, and partitions having arbitrary shapes.

A prediction mode of the prediction unit may be at least one of an intra mode, an inter mode, and a skip mode. For example, the intra mode or the inter mode may be performed on the partition of 2N×2N, 2N×N, N×2N, or N×N. Also, the skip mode may be performed only on the partition of 2N×2N. The encoding is independently performed on one prediction unit in a coding unit, thereby selecting a prediction mode having a least encoding error.

The video encoding apparatus 100 may also perform the transformation on the image data in a coding unit based not only on the coding unit for encoding the image data, but also based on a transformation unit that is different from the coding unit. In order to perform the transformation in the coding unit, the transformation may be performed based on a data unit having a size smaller than or equal to the coding unit. For example, the transformation unit for the transformation may include a transformation unit for an intra mode and a data unit for an inter mode.

Similarly to the coding unit according to the tree structure according to the present exemplary embodiment, the transformation unit in the coding unit may be recursively split into smaller sized regions and residual data in the coding unit may be divided according to the transformation having the tree structure according to transformation depths.

According to an exemplary embodiment, a transformation depth indicating the number of times splitting is performed to obtain the transformation unit by splitting the height and width of the coding unit may also be set in the transformation unit. For example, when the size of a transformation unit of a current coding unit is 2N×2N, a transformation depth may be set to 0. When the size of a transformation unit is N×N, the transformation depth may be set to 1. In addition, when the size of the transformation unit is N/2×N/2, the transformation depth may be set to 2. That is, the transformation unit according to the tree structure may also be set according to the transformation depth.

Encoding information according to coding units corresponding to a coded depth requires not only information about the coded depth, but also about information related to prediction encoding and transformation. Accordingly, the coding unit determiner 120 not only determines a coded depth having a least encoding error, but also determines a partition type in a prediction unit, a prediction mode according to prediction units, and a size of a transformation unit for transformation.

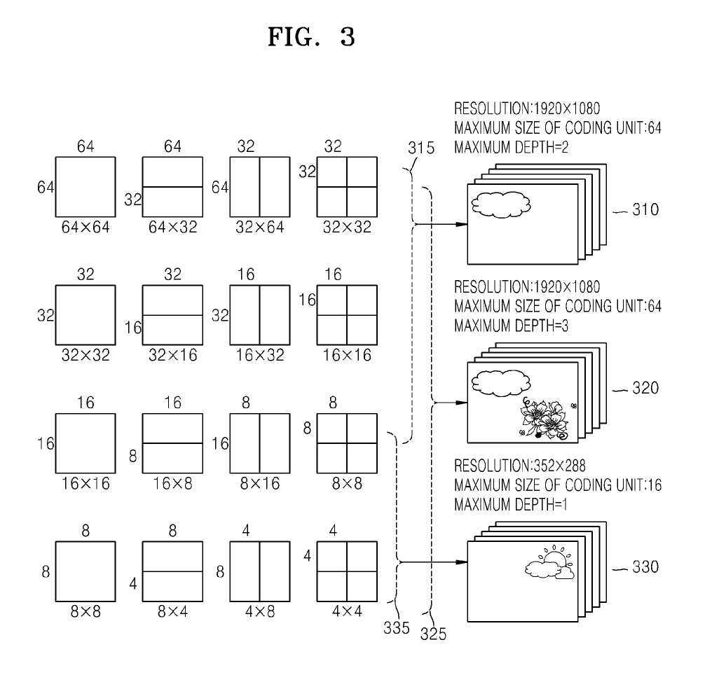

Coding units and a prediction unit/partition according to a tree structure in a maximum coding unit, and a method of determining a transformation unit, according to exemplary embodiments, will be described in detail later with reference to FIGS. 3 through 13.

The coding unit determiner 120 may measure an encoding error of deeper coding units according to depths by using Rate-Distortion Optimization based on Lagrangian multipliers.

The output unit 130 outputs the image data of the maximum coding unit, which is encoded based on the at least one coded depth determined by the coding unit determiner 120, and information about the encoding mode according to the coded depth, in bitstreams.

The encoded image data may be obtained by encoding residual data of an image.

The information about the encoding mode according to the coded depth may include information about the coded depth, the partition type in the prediction unit, the prediction mode, and the size of the transformation unit.

The information about the coded depth may be defined by using split information according to depths, which indicates whether encoding is performed on coding units of a lower depth instead of a current depth. If the current depth of the current coding unit is the coded depth, image data in the current coding unit is encoded and output, and thus, the split information may be defined not to split the current coding unit to a lower depth. Alternatively, if the current depth of the current coding unit is not the coded depth, the encoding is performed on the coding unit of the lower depth, and thus, the split information may be defined to split the current coding unit to obtain the coding units of the lower depth.

If the current depth is not the coded depth, encoding is performed on the coding unit that is split into the coding unit of the lower depth. Since at least one coding unit of the lower depth exists in one coding unit of the current depth, the encoding is repeatedly performed on each coding unit of the lower depth, and thus, the encoding may be recursively performed for the coding units having the same depth.

Since the coding units having a tree structure are determined for one maximum coding unit, and information about at least one encoding mode is determined for a coding unit of a coded depth, information about at least one encoding mode may be determined for one maximum coding unit. Also, a coded depth of the image data of the maximum coding unit may be different according to locations since the image data is hierarchically split according to depths, and thus, information about the coded depth and the encoding mode may be set for the image data.

Accordingly, the output unit 130 may assign encoding information about a corresponding coded depth and an encoding mode to at least one of the coding unit, the prediction unit, and a minimum unit included in the maximum coding unit.

The minimum unit according to an exemplary embodiment is a rectangular data unit obtained by splitting the minimum coding unit constituting the lowermost depth by 4. Alternatively, the minimum unit may be a maximum rectangular data unit having a maximum size, which is included in all of the coding units, prediction units, partition units, and transformation units included in the maximum coding unit.

For example, the encoding information output through the output unit 130 may be classified into encoding information according to coding units, and encoding information according to prediction units. The encoding information according to the coding units may include the information about the prediction mode and about the size of the partitions. The encoding information according to the prediction units may include information about an estimated direction of an inter mode, about a reference image index of the inter mode, about a motion vector, about a chroma component of an intra mode, and about an interpolation method of the intra mode.

Also, information about a maximum size of the coding unit defined according to pictures, slices, or GOPs, and information about a maximum depth may be inserted into a header of a bitstream, a sequence parameter set (SPS) or a picture parameter set (PPS).

In addition, information about a maximum size of a transformation unit and information about a minimum size of a transformation, which are acceptable for a current video, may also be output via a header of a bitstream, an SPS or a PPS. The output unit 130 may encode and output reference information, prediction information, bi-directional prediction information, and information about a slice type including a fourth slice type, which are related to prediction to be described with reference to FIGS. 1 through 6.

In the video encoding apparatus 100, the deeper coding unit may be a coding unit obtained by dividing a height or width of a coding unit of an upper depth, which is one depth higher than the current depth, by two. In other words, when the size of the coding unit of the current depth is 2N×2N, the size of the coding unit of the lower depth is N×N. Also, the coding unit of the current depth having the size of 2N×2N may include a maximum value 4 of the coding unit of the lower depth.

Accordingly, the video encoding apparatus 100 may form the coding units having the tree structure by determining coding units having an optimum shape and an optimum size for each maximum coding unit, based on the size of the maximum coding unit and the maximum depth determined considering characteristics of the current picture. Also, since encoding may be performed on each maximum coding unit by using any one of various prediction modes and transformations, an optimum encoding mode may be determined considering characteristics of the coding unit of various image sizes.

Thus, if an image having a high resolution or a large data amount is encoded in a conventional macroblock, a number of macroblocks per picture excessively increases. Accordingly, a number of pieces of compressed information generated for each macroblock increases, and thus, it is difficult to transmit the compressed information and data compression efficiency decreases. However, by using the video encoding apparatus 100, image compression efficiency may be increased since a coding unit is adjusted while considering characteristics of an image while increasing a maximum size of a coding unit while considering a size of the image.

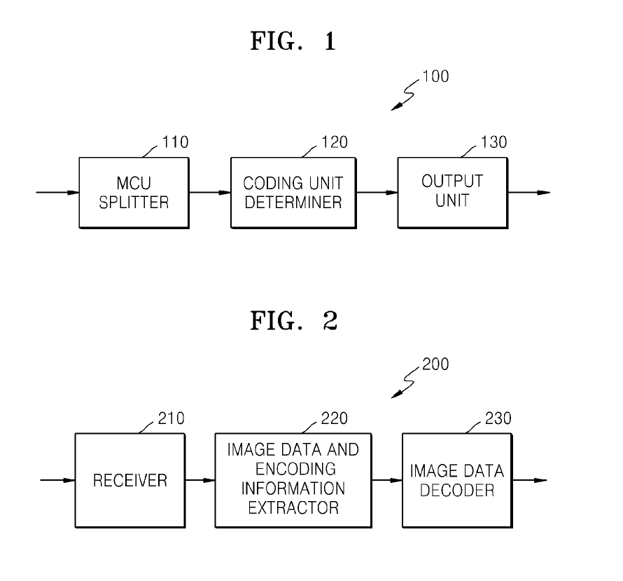

FIG. 2 is a block diagram of a video decoding apparatus 200 based on a coding unit according to a tree structure, according to an exemplary embodiment.

The video decoding apparatus 200, which is configured to perform a decoding operation based on video prediction based on the coding unit according to the tree structure according to an exemplary embodiment, includes a receiver 210, an image data and encoding information extractor 220, and an image data decoder 230. Hereinafter, for convenience of description, the video decoding apparatus 200, which is configured to perform a decoding operation based on video prediction based on the coding unit according to the tree structure, will be referred to as the “video decoding apparatus 200”.

Definitions of various terms, such as a coding unit, a depth, a prediction unit, a transformation unit, and information about various encoding modes, for decoding operations of the video decoding apparatus 200 may be identical to those described with reference to FIG. 1 and the video encoding apparatus 100.

The receiver 210 receives and parses a bitstream of an encoded video. The image data and encoding information extractor 220 extracts encoded image data for each coding unit from the parsed bitstream, wherein the coding units have a tree structure according to each maximum coding unit, and outputs the extracted image data to the image data decoder 230. The image data and encoding information extractor 220 may extract information about a maximum size of a coding unit of a current picture, from a header about the current picture, an SPS, or a PPS.

Also, the image data and encoding information extractor 220 extracts information about a coded depth and an encoding mode for the coding units having a tree structure according to each maximum coding unit, from the parsed bitstream. The extracted information about the coded depth and the encoding mode is output to the image data decoder 230. In other words, the image data in a bitstream is split into the maximum coding unit so that the image data decoder 230 decodes the image data for each maximum coding unit.

The information about the coded depth and the encoding mode according to the maximum coding unit may be set for information about at least one coding unit corresponding to the coded depth, and information about an encoding mode may include information about a partition type of a corresponding coding unit corresponding to the coded depth, about a prediction mode, and a size of a transformation unit. Also, splitting information according to depths may be extracted as the information about the coded depth.

The information about the coded depth and the encoding mode according to each maximum coding unit extracted by the image data and encoding information extractor 220 is information about a coded depth and an encoding mode determined to generate a minimum encoding error when an encoder, such as the video encoding apparatus 100, repeatedly performs encoding for each deeper coding unit according to depths according to each maximum coding unit. Accordingly, the video decoding apparatus 200 may restore an image by decoding the image data according to a coded depth and an encoding mode that generates the minimum encoding error.

Since encoding information about the coded depth and the encoding mode may be assigned to a predetermined data unit from among a corresponding coding unit, a prediction unit, and a minimum unit, the image data and encoding information extractor 220 may extract the information about the coded depth and the encoding mode according to the predetermined data units. The predetermined data units to which the same information about the coded depth and the encoding mode is assigned may be inferred to be the data units included in the same maximum coding unit.

The image data decoder 230 restores the current picture by decoding the image data in each maximum coding unit based on the information about the coded depth and the encoding mode according to the maximum coding units. In other words, the image data decoder 230 may decode the encoded image data based on the extracted information about the partition type, the prediction mode, and the transformation unit for each coding unit from among the coding units having the tree structure included in each maximum coding unit. A decoding process may include prediction including intra prediction and motion compensation, and inverse transformation. Inverse transformation may be performed according to a method of inverse orthogonal transformation or inverse integer transformation.

The image data decoder 230 may perform intra prediction or motion compensation according to a partition and a prediction mode of each coding unit, based on the information about the partition type and the prediction mode of the prediction unit of the coding unit according to coded depths.

In addition, the image data decoder 230 may read transformation unit information according to a tree structure for each coding unit so as to determine transform units for each coding unit in each maximum coding unit and perform inverse transformation based on transformation units for each coding unit, for inverse transformation for each maximum coding unit. Via the inverse transformation, a pixel value of a spatial region of the coding unit may be restored.

The image data decoder 230 may determine at least one coded depth of a current maximum coding unit by using split information according to depths. If the split information indicates that image data is no longer split in the current depth, the current depth is a coded depth. Accordingly, the image data decoder 230 may decode encoded data of at least one coding unit corresponding to each coded depth in the current maximum coding unit by using the information about the partition type of the prediction unit, the prediction mode, and the size of the transformation unit for each coding unit corresponding to the coded depth, and output the image data of the current maximum coding unit.

In other words, data units containing the encoding information including the same split information may be gathered by observing the encoding information set assigned for the predetermined data unit from among the coding unit, the prediction unit, and the minimum unit, and the gathered data units may be considered to be one data unit to be decoded by the image data decoder 230 in the same encoding mode. For each coding unit determined as described above, information about an encoding mode may be obtained so as to decode the current coding unit.

The video decoding apparatus 200 may obtain information about at least one coding unit that generates the minimum encoding error when encoding is recursively performed for each maximum coding unit, and may use the information to decode the current picture. In other words, the coding units having the tree structure determined to be the optimum coding units in each maximum coding unit may be decoded. Also, the maximum size of a coding unit is determined considering a resolution and an amount of image data.

Accordingly, even if image data has high resolution and a large amount of data, the image data may be efficiently decoded and restored by using a size of a coding unit and an encoding mode, which are adaptively determined according to characteristics of the image data, by using information about an optimum encoding mode received from an encoder.

FIG. 3 is a diagram for describing a concept of coding units according to an exemplary embodiment.

A size of a coding unit may be expressed in width×height, and may be 64×64, 32×32, 16×16, and 8×8. A coding unit of 64×64 may be split into partitions of 64×64, 64×32, 32×64, or 32×32, a coding unit of 32×32 may be split into partitions of 32×32, 32×16, 16×32, or 16×16, a coding unit of 16×16 may be split into partitions of 16×16, 16×8, 8×16, or 8×8, and a coding unit of 8×8 may be split into partitions of 8×8, 8×4, 4×8, or 4×4.

In video data 310, a resolution is 1920×1080, a maximum size of a coding unit is 64, and a maximum depth is 2. In video data 320, a resolution is 1920×1080, a maximum size of a coding unit is 64, and a maximum depth is 3. In video data 330, a resolution is 352×288, a maximum size of a coding unit is 16, and a maximum depth is 1. The maximum depth shown in FIG. 3 denotes a total number of splits from a maximum coding unit to a minimum decoding unit.

If a resolution is high or a data amount is large, a maximum size of a coding unit may be large so as to not only increase encoding efficiency but also to accurately reflect characteristics of an image. Accordingly, the maximum size of the coding unit of the video data 310 and 320 having a higher resolution than the video data 330 may be 64.

Since the maximum depth of the video data 310 is 2, coding units 315 of the video data 310 may include a maximum coding unit having a long axis size of 64, and coding units having long axis sizes of 32 and 16 since depths are deepened to two layers by splitting the maximum coding unit twice. Meanwhile, since the maximum depth of the video data 330 is 1, coding units 335 of the video data 330 may include a maximum coding unit having a long axis size of 16, and coding units having a long axis size of 8 since depths are deepened to one layer by splitting the maximum coding unit once.

Since the maximum depth of the video data 320 is 3, coding units 325 of the video data 320 may include a maximum coding unit having a long axis size of 64, and coding units having long axis sizes of 32, 16, and 8 since the depths are deepened to 3 layers by splitting the maximum coding unit three times. As a depth deepens, detailed information may be precisely expressed.

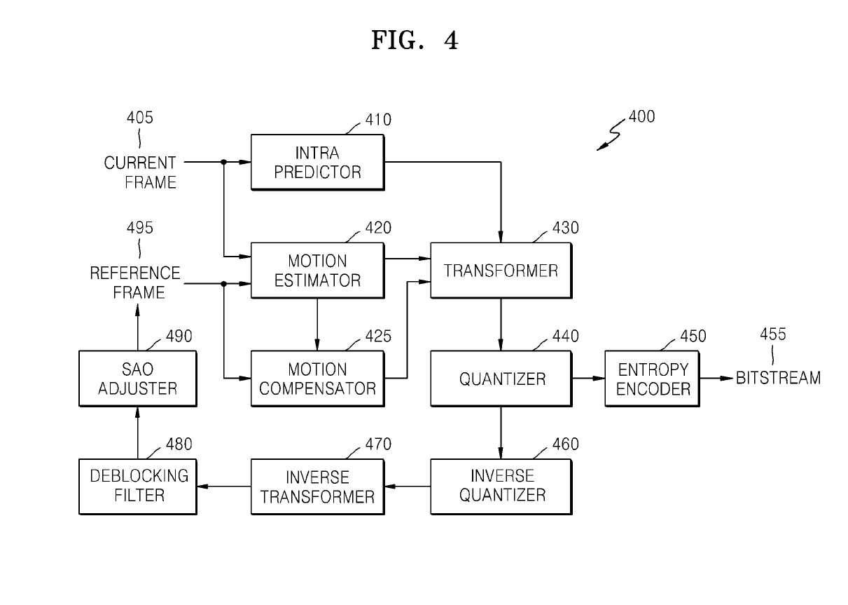

FIG. 4 is a block diagram of an image encoder 400 based on coding units, according to an exemplary embodiment.

The image encoder 400 performs operations of the coding unit determiner 120 of the video encoding apparatus 100 to encode image data. In other words, an intra predictor 410 performs intra prediction on coding units in an intra mode from among a current frame 405, and a motion estimator 420 and a motion compensator 425 perform inter estimation and motion compensation on coding units in an inter mode from among the current frame 405 by using the current frame 405 and a reference frame 495.

Data output from the intra predictor 410, the motion estimator 420, and the motion compensator 425 is output as quantized transformation coefficients through a transformer 430 and a quantizer 440. The quantized transformation coefficients are restored as data in a spatial domain through an inverse quantizer 460 and an inverse transformer 470, and the restored data in the spatial domain is output as the reference frame 495 after being post-processed through a deblocking unit 480 and an offset (sample adaptive offset (SAO)) adjuster 490. The quantized transformation coefficients may be output as a bitstream 455 through an entropy encoder 450.

In order for the image encoder 400 to be implemented in the video encoding apparatus 100 according to an exemplary embodiment, all of the elements of the image encoder 400, e.g., the intra predictor 410, the motion estimator 420, the motion compensator 425, the transformer 430, the quantizer 440, the entropy encoder 450, the inverse quantizer 460, the inverse transformer 470, the deblocking unit 480, and the SAO adjuster 490 perform operations based on each coding unit from among coding units having a tree structure while considering the maximum depth of each maximum coding unit.

Specifically, the intra predictor 410, the motion estimator 420, and the motion compensator 425 determine partitions and a prediction mode of each coding unit from among the coding units having a tree structure while considering the maximum size and the maximum depth of a current maximum coding unit, and the transformer 430 determines the size of the transformation unit in each coding unit from among the coding units having a tree structure.

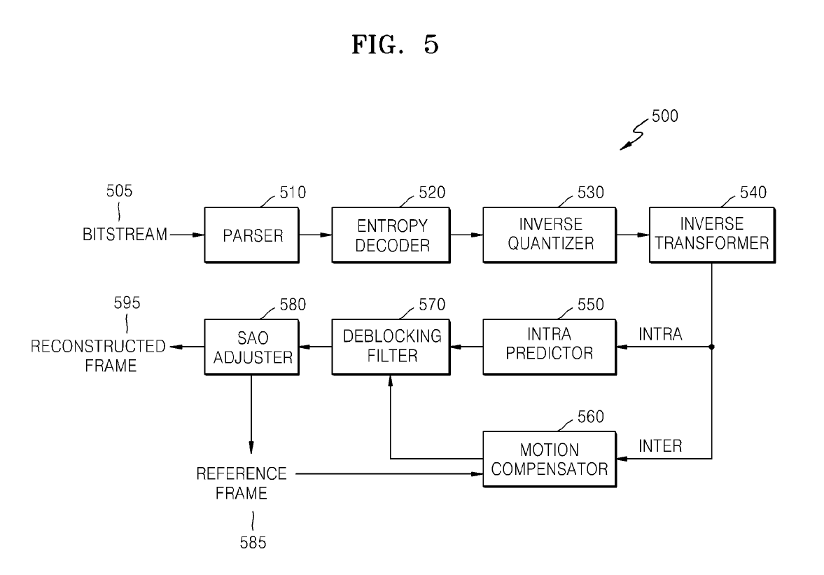

FIG. 5 is a block diagram of an image decoder 500 based on coding units, according to an exemplary embodiment.

A parser 510 parses encoded image data to be decoded and information about encoding required for decoding from a bitstream 505. The encoded image data is output as inverse quantized data through an entropy decoder 520 and an inverse quantizer 530, and the inverse quantized data is restored to image data in a spatial domain through an inverse transformer 540.

An intra predictor 550 performs intra prediction on coding units in an intra mode with respect to the image data in the spatial domain, and a motion compensator 560 performs motion compensation on coding units in an inter mode by using a reference frame 585.

The image data in the spatial domain, which passed through the intra predictor 550 and the motion compensator 560, may be output as a restored frame 595 after being post-processed through a deblocking filter 570 and an SAO adjuster 580. Also, the image data that is post-processed through the deblocking unit 570 and the SAO adjuster 580 may be output as the reference frame 585.

In order to decode the image data in the image data decoder 230 of the video decoding apparatus 200, the image decoder 500 may perform operations that are performed after the parser 510 performs an operation.

In order for the image decoder 500 to be implemented in the video decoding apparatus 200 according to an exemplary embodiment, all of the elements of the image decoder 500, e.g., the parser 510, the entropy decoder 520, the inverse quantizer 530, the inverse transformer 540, the intra predictor 550, the motion compensator 560, the deblocking filter 570, and the SAO adjuster 580 perform operations based on coding units having a tree structure for each maximum coding unit.

Specifically, the intra predictor 550 and the motion compensator 560 perform operations based on partitions and a prediction mode for each of the coding units having a tree structure, and the inverse transformer 540 performs operations based on a size of a transformation unit for each coding unit.

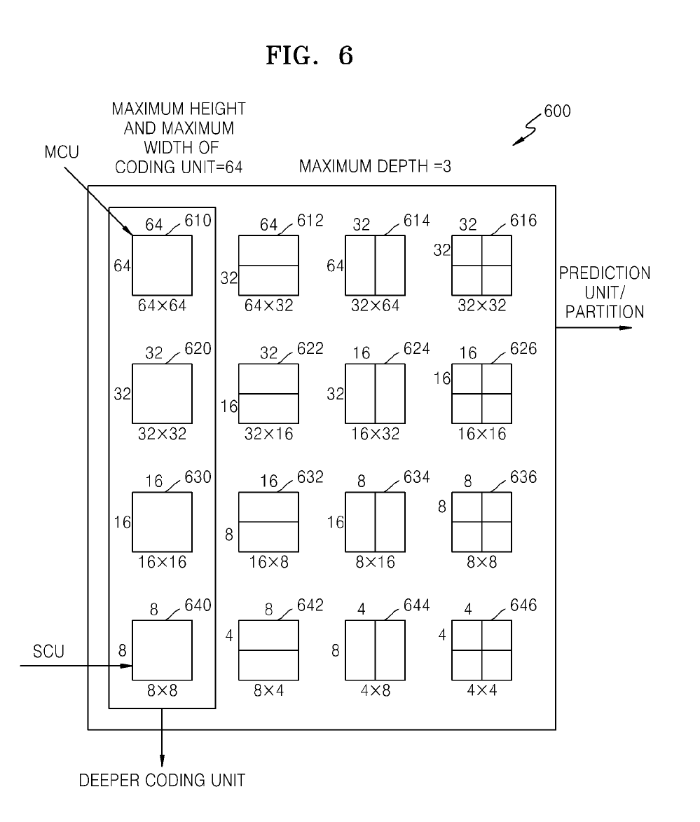

FIG. 6 is a diagram illustrating deeper coding units according to depths, and partitions, according to an exemplary embodiment.

The video encoding apparatus 100 according to an exemplary embodiment and the video decoding apparatus 200 according to an exemplary embodiment use hierarchical coding units so as to consider characteristics of an image. A maximum height, a maximum width, and a maximum depth of coding units may be adaptively determined according to the characteristics of the image, or may be differently set by a user. Sizes of deeper coding units according to depths may be determined according to the predetermined maximum size of the coding unit.

In a hierarchical structure 600 of coding units according to an exemplary embodiment, the maximum height and the maximum width of the coding units are each 64, and the maximum depth is 3. In this case, the maximum depth refers to a total number of times the coding unit is split from the maximum coding unit to the minimum coding unit. Since a depth deepens along a vertical axis of the hierarchical structure 600, a height and a width of the deeper coding unit are each split. Also, a prediction unit and partitions, which are bases for prediction encoding of each deeper coding unit, are shown along a horizontal axis of the hierarchical structure 600.

In other words, a coding unit 610 is a maximum coding unit in the hierarchical structure 600, wherein a depth is 0 and a size, e.g., a height by width, is 64×64. The depth deepens along the vertical axis, and a coding unit 620 having a size of 32×32 and a depth of 1, a coding unit 630 having a size of 16×16 and a depth of 2, and a coding unit 640 having a size of 8×8 and a depth of 3 are provided. The coding unit 640 having the size of 8×8 and the depth of 3 is a minimum coding unit.

The prediction unit and the partitions of a coding unit are arranged along the horizontal axis according to each depth. In other words, if the coding unit 610 having the size of 64×64 and the depth of 0 is a prediction unit, the prediction unit may be split into partitions included in the encoding unit 610, e.g., a partition 610 having a size of 64×64, partitions 612 having the size of 64×32, partitions 614 having the size of 32×64, or partitions 616 having the size of 32×32.

Similarly, a prediction unit of the coding unit 620 having the size of 32×32 and the depth of 1 may be split into partitions included in the coding unit 620, e.g., a partition 620 having a size of 32×32, partitions 622 having a size of 32×16, partitions 624 having a size of 16×32, and partitions 626 having a size of 16×16.

Similarly, a prediction unit of the coding unit 630 having the size of 16×16 and the depth of 2 may be split into partitions included in the coding unit 630, e.g., a partition having a size of 16×16 included in the coding unit 630, partitions 632 having a size of 16×8, partitions 634 having a size of 8×16, and partitions 636 having a size of 8×8.

Similarly, a prediction unit of the coding unit 640 having the size of 8×8 and the depth of 3 may be split into partitions included in the coding unit 640, e.g., a partition having a size of 8×8 included in the coding unit 640, partitions 642 having a size of 8×4, partitions 644 having a size of 4×8, and partitions 646 having a size of 4×4.

Finally, the coding unit 640 having the size of 8×8 and the depth of 3 is the minimum coding unit and a coding unit of the lowermost depth.

In order to determine the at least one coded depth of the coding units constituting the maximum coding unit 610, the coding unit determiner 120 of the video encoding apparatus 100 according to an exemplary embodiment performs encoding for coding units corresponding to each depth included in the maximum coding unit 610.

A number of deeper coding units according to depths including data in the same range and the same size increases as the depth deepens. For example, four coding units corresponding to a depth of 2 are required to cover data that is included in one coding unit corresponding to a depth of 1. Accordingly, in order to compare encoding results of the same data according to depths, the coding unit corresponding to the depth of 1 and four coding units corresponding to the depth of 2 are each encoded.

In order to perform encoding for a current depth from among the depths, a least encoding error may be selected for the current depth by performing encoding for each prediction unit in the coding units corresponding to the current depth, along the horizontal axis of the hierarchical structure 600. Alternatively, the minimum encoding error may be searched for by comparing the least encoding errors according to depths, by performing encoding for each depth as the depth deepens along the vertical axis of the hierarchical structure 600. A depth and a partition having the minimum encoding error in the coding unit 610 may be selected as the coded depth and a partition type of the coding unit 610.

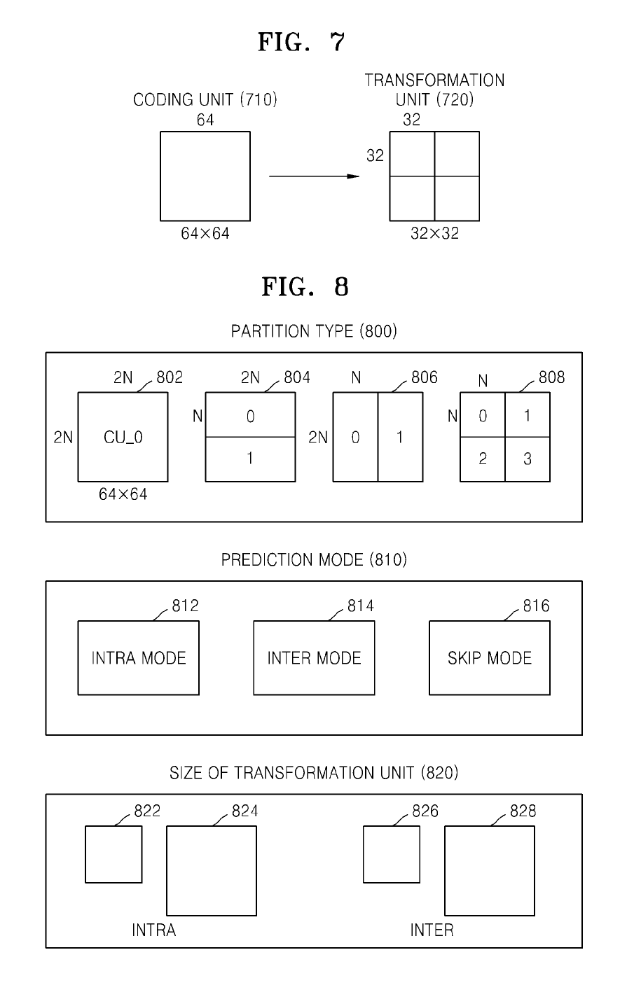

FIG. 7 is a diagram for describing a relationship between a coding unit 710 and transformation units 720, according to an exemplary embodiment.

The video encoding apparatus 100 according to an exemplary embodiment or the video decoding apparatus 200 according to an exemplary embodiment encodes or decodes an image according to coding units having sizes smaller than or equal to a maximum coding unit for each maximum coding unit. Sizes of transformation units for transformation during encoding may be selected based on data units that are not larger than a corresponding coding unit.

For example, in the video encoding apparatus 100 according to an exemplary embodiment or the video decoding apparatus 200 according to an exemplary embodiment, if a size of the coding unit 710 is 64×64, transformation may be performed by using the transformation units 720 having a size of 32×32.

Also, data of the coding unit 710 having the size of 64×64 may be encoded by performing the transformation on each of the transformation units having the size of 32×32, 16×16, 8×8, and 4×4, which are smaller than 64×64, and then a transformation unit having the least coding error may be selected.

FIG. 8 is a diagram for describing encoding information of coding units corresponding to a coded depth, according to an exemplary embodiment.

The output unit 130 of the video encoding apparatus 100 according to an exemplary embodiment may encode and transmit information 800 about a partition type, information 810 about a prediction mode, and information 820 about a size of a transformation unit for each coding unit corresponding to a coded depth, as information about an encoding mode.

The information 800 indicates information about a shape of a partition obtained by splitting a prediction unit of a current coding unit, wherein the partition is a data unit for prediction encoding the current coding unit. For example, a current coding unit CU_{—}0 having a size of 2N×2N may be split into any one of a partition 802 having a size of 2N×2N, a partition 804 having a size of 2N×N, a partition 806 having a size of N×2N, and a partition 808 having a size of N×N. Here, the information 800 about a partition type is set to indicate one of the partition 804 having a size of 2N×N, the partition 806 having a size of N×2N, and the partition 808 having a size of N×N

The information 810 indicates a prediction mode of each partition. For example, the information 810 may indicate a mode of prediction encoding performed on a partition indicated by the information 800, e.g., an intra mode 812, an inter mode 814, or a skip mode 816.

The information 820 indicates a transformation unit for transformation to be based on when transformation is performed on a current coding unit. For example, the transformation unit may be a first intra transformation unit 822, a second intra transformation unit 824, a first inter transformation unit 826, or a second inter transformation unit 828.

The image data and encoding information extractor 220 of the video decoding apparatus 200 may extract and use the information 800, 810, and 820 for decoding, according to each deeper coding unit.

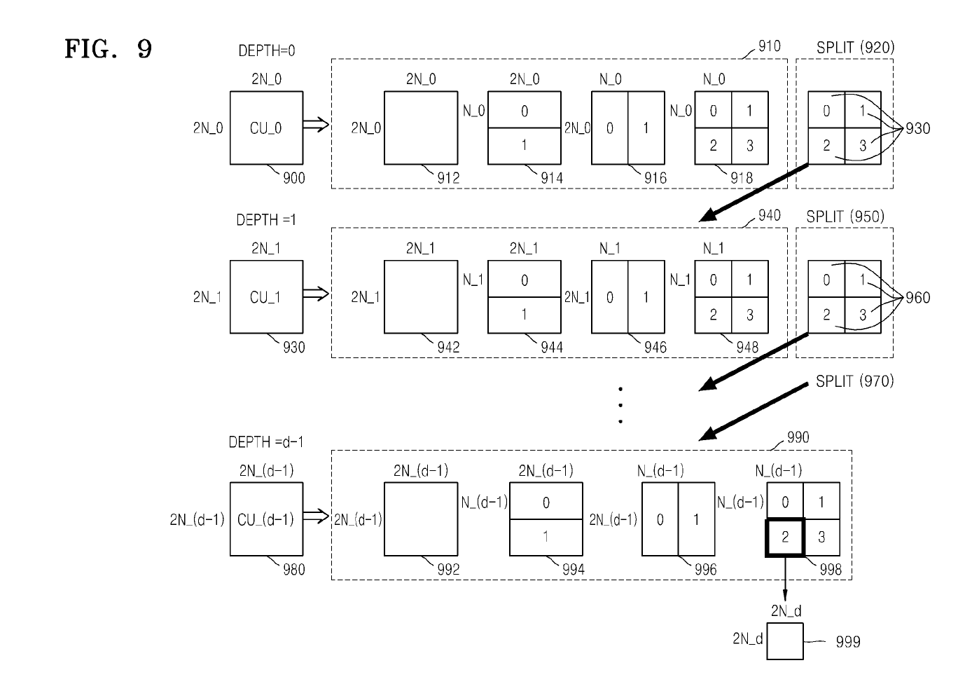

FIG. 9 is a diagram of deeper coding units according to depths, according to an exemplary embodiment.

Split information may be used to indicate a change of a depth. The spilt information indicates whether a coding unit of a current depth is split into coding units of a lower depth.

A prediction unit 910 for prediction encoding a coding unit 900 having a depth of 0 and a size of 2N_{—}0×2N_{—}0 may include partitions of a partition type 912 having a size of 2N_{—}0×2N_{—}0, a partition type 914 having a size of 2N_{—}0×N_{—}0, a partition type 916 having a size of N_{—}0×2N_{—}0, and a partition type 918 having a size of N_{—}0×N_{—}0. FIG. 9 only illustrates the partition types 912 through 918 which are obtained by symmetrically splitting the prediction unit 910, but a partition type is not limited thereto, and the partitions of the prediction unit 910 may include asymmetrical partitions, partitions having a predetermined shape, and partitions having a geometrical shape.

Prediction encoding is repeatedly performed on one partition having a size of 2N_{—}0×2N_{—}0, two partitions having a size of 2N_{—}0×N_{—}0, two partitions having a size of N_{—}0×2N_{—}0, and four partitions having a size of N_{—}0×N_{—}0, according to each partition type. The prediction encoding in an intra mode and an inter mode may be performed on the partitions having the sizes of 2N_{—}0×2N_{—}0, N_{—}0×2N_{—}0, 2 N_{—}0×N_{—}0, and N_{—}0×N_{—}0. The prediction encoding in a skip mode is performed only on the partition having the size of 2N_{—}0×2N_{—}0.

Errors of encoding including the prediction encoding in the partition types 912 through 918 are compared, and the least encoding error is determined among the partition types. If an encoding error is smallest in one of the partition types 912 through 916, the prediction unit 910 may not be split into a lower depth.

If the encoding error is the smallest in the partition type 918, a depth is changed from 0 to 1 to split the partition type 918 in operation 920, and encoding is repeatedly performed on coding units 930 having a depth of 2 and a size of N_{—}0×N_{—}0 to search for a minimum encoding error.

A prediction unit 940 for prediction encoding the coding unit 930 having a depth of 1 and a size of 2N_{—}1×2N_{—}1 (=N_{—}0×N_{—}0) may include partitions of a partition type 942 having a size of 2N_{—}1×2N_{—}1, a partition type 944 having a size of 2N_{—}1×N_{—}1, a partition type 946 having a size of N_{—}1×2N_{—}1, and a partition type 948 having a size of N_{—}1×N_{—}1.

If an encoding error is the smallest in the partition type 948, a depth is changed from 1 to 2 to split the partition type 948 in operation 950, and encoding is repeatedly performed on coding units 960, which have a depth of 2 and a size of N_{—}2×N_{—}2 to search for a minimum encoding error.

When a maximum depth is d, a split operation according to each depth may be performed until a depth becomes d-1, and split information may be encoded for up to when a depth is one of 0 to d-2. In other words, when encoding is performed until the depth is d-1 after a coding unit corresponding to a depth of d-2 is split in operation 970, a prediction unit 990 for prediction encoding a coding unit 980 having a depth of d-1 and a size of 2N_(d-1)×2N_(d−1) may include partitions of a partition type 992 having a size of 2N_(d-1)×2N_(d−1), a partition type 994 having a size of 2N_(d-1)×N_(d−1), a partition type 996 having a size of N_(d-1)×2N_(d−1), and a partition type 998 having a size of N_(d-1)×N_(d−1).

Prediction encoding may be repeatedly performed on one partition having a size of 2N_(d−1)×2N_(d−1), two partitions having a size of 2N_(d−1)×N_(d-1), two partitions having a size of N_(d−1)×2N_(d−1), four partitions having a size of N_(d−1)×N_(d−1) from among the partition types 992 through 998 to search for a partition type having a minimum encoding error.

Even when the partition type 998 has the minimum encoding error, since a maximum depth is d, a coding unit CU_(d−1) having a depth of d-1 is no longer split to a lower depth, and a coded depth for the coding units constituting a current maximum coding unit 900 is determined to be d-1 and a partition type of the current maximum coding unit 900 may be determined to be N_(d−1)×N_(d-1). Also, since the maximum depth is d and a minimum coding unit 980 having a lowermost depth of d-1 is no longer split to a lower depth, split information for the minimum coding unit 980 is not set.

A data unit 999 may be a ‘minimum unit’ for the current maximum coding unit. A minimum unit according to an exemplary embodiment may be a rectangular data unit obtained by splitting a minimum coding unit 980 by 4. By performing the encoding repeatedly, the video encoding apparatus 100 according to an exemplary embodiment may select a depth having the least encoding error by comparing encoding errors according to depths of the coding unit 900 to determine a coded depth, and set a corresponding partition type and a prediction mode as an encoding mode of the coded depth.

As such, the minimum encoding errors according to depths are compared in all of the depths of 1 through d, and a depth having the least encoding error may be determined as a coded depth. The coded depth, the partition type of the prediction unit, and the prediction mode may be encoded and transmitted as information about an encoding mode. Also, since a coding unit is split from a depth of 0 to a coded depth, only split information of the coded depth is set to 0, and split information of depths excluding the coded depth is set to 1.

The image data and encoding information extractor 220 of the video decoding apparatus 200 may extract and use the information about the coded depth and the prediction unit of the coding unit 900 to decode the partition 912. The video decoding apparatus 200 may determine a depth, in which split information is 0, as a coded depth by using split information according to depths, and use information about an encoding mode of the corresponding depth for decoding.

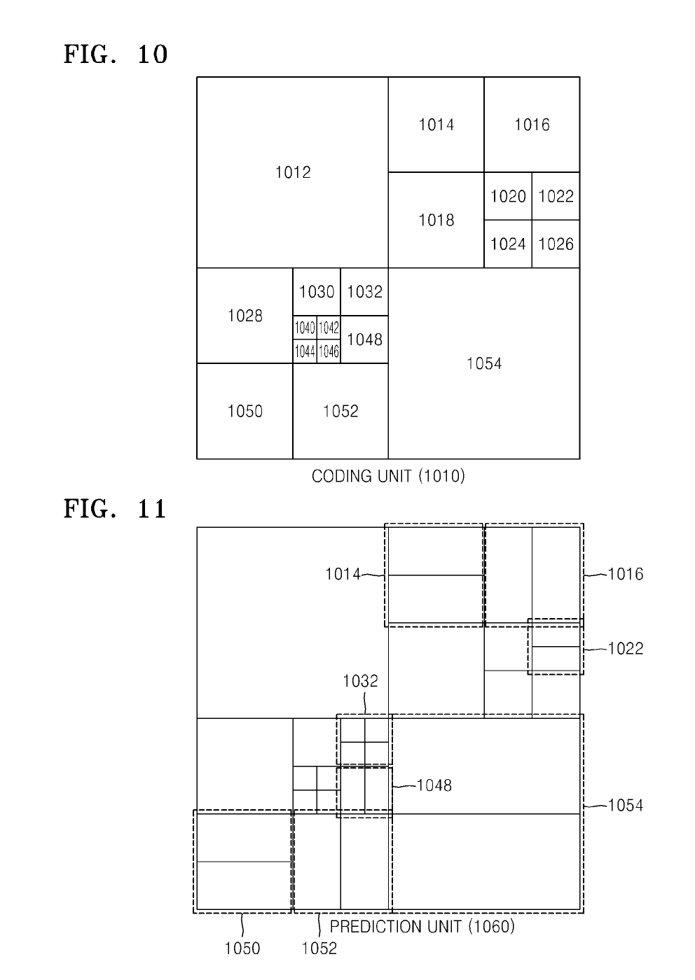

FIGS. 10 through 12 are diagrams for describing a relationship between coding units 1010, prediction units 1060, and transformation units 1070, according to an exemplary embodiment.

The coding units 1010 are coding units having a tree structure, corresponding to coded depths determined by the video encoding apparatus 100 according to an exemplary embodiment, in a maximum coding unit. The prediction units 1060 are partitions of prediction units of each of the coding units 1010, and the transformation units 1070 are transformation units of each of the coding units 1010.

When a depth of a maximum coding unit is 0 in the coding units 1010, depths of coding units 1012 and 1054 are 1, depths of coding units 1014, 1016, 1018, 1028, 1050, and 1052 are 2, depths of coding units 1020, 1022, 1024, 1026, 1030, 1032, and 1048 are 3, and depths of coding units 1040, 1042, 1044, and 1046 are 4.

In the prediction units 1060, some encoding units 1014, 1016, 1022, 1032, 1048, 1050, 1052, and 1054 are obtained by splitting the coding units in the encoding units 1010. In other words, partition types in the coding units 1014, 1022, 1050, and 1054 have a size of 2N×N, partition types in the coding units 1016, 1048, and 1052 have a size of N×2N, and a partition type of the coding unit 1032 has a size of N×N. Prediction units and partitions of the coding units 1010 are smaller than or equal to each coding unit.

Transformation or inverse transformation is performed on image data of the coding unit 1052 in the transformation units 1070 in a data unit that is smaller than the coding unit 1052. Also, the coding units 1014, 1016, 1022, 1032, 1048, 1050, and 1052 in the transformation units 1070 are different from those in the prediction units 1060 in terms of sizes and shapes. In other words, the video encoding apparatus 100 according to an exemplary embodiment and the video decoding apparatus 200 according to an exemplary embodiment may perform intra prediction, motion estimation, motion compensation, transformation, and inverse transformation individually on a data unit in the same coding unit.

Accordingly, encoding is recursively performed on each of the coding units having a hierarchical structure in each region of a maximum coding unit to determine an optimum coding unit, and thus, coding units having a recursive tree structure may be obtained. Encoding information may include split information about a coding unit, information about a partition type, information about a prediction mode, and information about a size of a transformation unit. Table 1 shows the encoding information that may be set by the video encoding apparatus 100 according to an exemplary embodiment and the video decoding apparatus 200 according to an exemplary embodiment.

TABLE 1

| Split Information 0 | | | | | Split |
|---|---|---|---|---|---|
| (Encoding on Coding Unit having Size of 2N × 2N and Current Depth of d) | | | | | Information 1 |
| Prediction | Partition Type | | Size of Transformation Unit | | Repeatedly |
| Mode | | | | | Encode |
| Intra | Symmetrical | Asymmetrical | Split | Split | Coding Units |
| Inter | Partition | Partition | Information 0 of | Information 1 of | having |
| Skip | Type | Type | Transformation | Transformation | Lower Depth |
| (Only | | | Unit | Unit | of d + 1 |
| 2N × 2N) | 2N × 2N | 2N × nU | 2N × 2N | N × N | |
| | 2N × N | 2N × nD | | (Symmetrical | |
| | N × 2N | nL × 2N | | Partition Type) | |
| | N × N | nR × 2N | | | |

The output unit 130 of the video encoding apparatus 100 according to exemplary an embodiment may output the encoding information about the coding units having a tree structure, and the image data and encoding information extractor 220 of the video decoding apparatus 200 according to an exemplary embodiment may extract the encoding information about the coding units having a tree structure from a received bitstream.

Split information indicates whether a current coding unit is split into coding units of a lower depth. If split information of a current depth d is 0, a depth, in which a current coding unit is no longer split into a lower depth, is a coded depth, and thus, information about a partition type, prediction mode, and a size of a transformation unit may be defined for the coded depth. If the current coding unit is further split according to the split information, encoding is independently performed on four split coding units of a lower depth.

A prediction mode may be one of an intra mode, an inter mode, and a skip mode. The intra mode and the inter mode may be defined in all partition types, and the skip mode is defined only in a partition type having a size of 2N×2N.

The information about the partition type may indicate symmetrical partition types having sizes of 2N×2N, 2N×N, N×2N, and N×N, which are obtained by symmetrically splitting a height or a width of a prediction unit, and asymmetrical partition types having sizes of 2N×nU, 2N×nD, nL×2N, and nR×2N, which are obtained by asymmetrically splitting the height or width of the prediction unit. The asymmetrical partition types having the sizes of 2N×nU and 2N×nD may be respectively obtained by splitting the height of the prediction unit in 1:3 and 3:1, and the asymmetrical partition types having the sizes of nL×2N and nR×2N may be respectively obtained by splitting the width of the prediction unit in 1:3 and 3:1

The size of the transformation unit may be set to be two types in the intra mode and two types in the inter mode. In other words, if split information of the transformation unit is 0, the size of the transformation unit may be 2N×2N, which is the size of the current coding unit. If split information of the transformation unit is 1, the transformation units may be obtained by splitting the current coding unit. Also, if a partition type of the current coding unit having the size of 2N×2N is a symmetrical partition type, a size of a transformation unit may be N×N, and if the partition type of the current coding unit is an asymmetrical partition type, the size of the transformation unit may be N/2×N/2.

The encoding information about coding units having a tree structure may include at least one of a coding unit corresponding to a coded depth, a prediction unit, and a minimum unit. The coding unit corresponding to the coded depth may include at least one of a prediction unit and a minimum unit containing the same encoding information.

Accordingly, it is determined whether adjacent data units are included in the same coding unit corresponding to the coded depth by comparing encoding information of the adjacent data units. Also, a corresponding coding unit corresponding to a coded depth is determined by using encoding information of a data unit, and thus, a distribution of coded depths in a maximum coding unit may be determined.

Accordingly, if a current coding unit is predicted based on encoding information of adjacent data units, encoding information of data units in deeper coding units adjacent to the current coding unit may be directly referred to and used.

Alternatively, if a current coding unit is predicted based on encoding information of adjacent data units, data units adjacent to the current coding unit are searched using encoded information of the data units, and the searched adjacent coding units may be referred to for predicting the current coding unit.

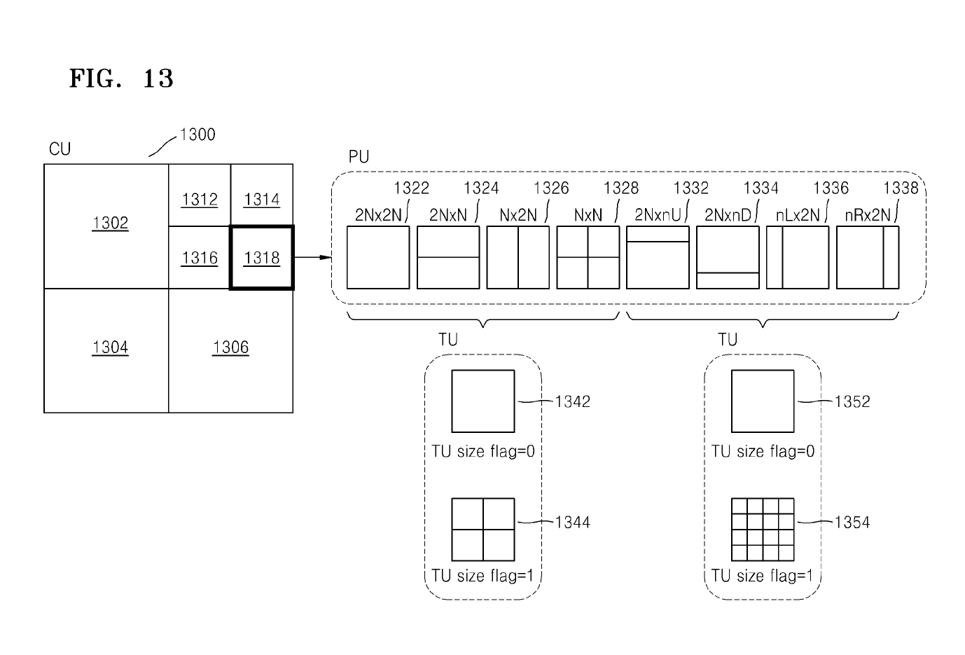

FIG. 13 is a diagram for describing a relationship between a coding unit, a prediction unit or a partition, and a transformation unit, according to encoding mode information of Table 1.

A maximum coding unit 1300 includes coding units 1302, 1304, 1306, 1312, 1314, 1316, and 1318 of coded depths. Here, since the coding unit 1318 is a coding unit of a coded depth, split information may be set to 0. Information about a partition type of the coding unit 1318 having a size of 2N×2N may be set to be one of a partition type 1322 having a size of 2N×2N, a partition type 1324 having a size of 2N×N, a partition type 1326 having a size of N×2N, a partition type 1328 having a size of N×N, a partition type 1332 having a size of 2N×nU, a partition type 1334 having a size of 2N×nD, a partition type 1336 having a size of nL×2N, and a partition type 1338 having a size of nR×2N.

Split information (TU (Transformation Unit) size flag) of a transformation unit is a type of a transformation index. The size of the transformation unit corresponding to the transformation index may be changed according to a prediction unit type or partition type of the coding unit.

For example, when the partition type is set to be symmetrical, e.g., the partition type 1322, 1324, 1326, or 1328, a transformation unit 1342 having a size of 2N×2N is set if split information (TU size flag) of a transformation unit is 0, and a transformation unit 1344 having a size of N×N is set if a TU size flag is 1.

When the partition type is set to be asymmetrical, e.g., the partition type 1332, 1334, 1336, or 1338, a transformation unit 1352 having a size of 2N×2N is set if a TU size flag is 0, and a transformation unit 1354 having a size of N/2×N/2 is set if a TU size flag is 1.

Referring to FIG. 13, the TU size flag is a flag having a value or 0 or 1, but the TU size flag is not limited to 1 bit, and a transformation unit may be hierarchically split having a tree structure while the TU size flag increases from 0. Split information (TU size flag) of a transformation unit may be an example of a transformation index.

In this case, the size of a transformation unit that has been actually used may be expressed by using a TU size flag of a transformation unit, according to an exemplary embodiment, together with a maximum size and minimum size of the transformation unit. According to an exemplary embodiment, the video encoding apparatus 100 is capable of encoding maximum transformation unit size information, minimum transformation unit size information, and a maximum TU size flag. A result of encoding the maximum transformation unit size information, the minimum transformation unit size information, and the maximum TU size flag may be inserted into an SPS. According to an exemplary embodiment, the video decoding apparatus 200 may decode video by using the maximum transformation unit size information, the minimum transformation unit size information, and the maximum TU size flag.

For example, if the size of a current coding unit is 64×64 and a maximum transformation unit size is 32×32, then the size of a transformation unit may be 32×32 when a TU size flag is 0, may be 16×16 when the TU size flag is 1, and may be 8×8 when the TU size flag is 2.

As another example, if the size of the current coding unit is 32×32 and a minimum transformation unit size is 32×32, then the size of the transformation unit may be 32×32 when the TU size flag is 0. Here, the TU size flag cannot be set to a value other than 0, since the size of the transformation unit cannot be less than 32×32.

As another example, if the size of the current coding unit is 64×64 and a maximum TU size flag is 1, then the TU size flag may be 0 or 1. Here, the TU size flag cannot be set to a value other than 0 or 1.

Thus, if it is defined that the maximum TU size flag is ‘MaxTransformSizeIndex’, a minimum transformation unit size is ‘MinTransformSize’, and a transformation unit size is ‘RootTuSize’ when the TU size flag is 0, then a current minimum transformation unit size ‘CurrMinTuSize’ that can be determined in a current coding unit, may be defined by Equation (1):

CurrMinTuSize=max(MinTransformSize,RootTuSize/(2″MaxTransformSizeIndex)) Equation (1)

Compared to the current minimum transformation unit size ‘CurrMinTuSize’ that can be determined in the current coding unit, a transformation unit size ‘RootTuSize’ when the TU size flag is 0 may denote a maximum transformation unit size that can be selected in the system. In Equation (1), ‘RootTuSize/(2̂MaxTransformSizeIndex)’ denotes a transformation unit size when the transformation unit size ‘RootTuSize’, when the TU size flag is 0, is split a number of times corresponding to the maximum TU size flag, and ‘MinTransformSize’ denotes a minimum transformation size. Thus, a smaller value from among ‘RootTuSize/(2̂MaxTransformSizeIndex)’ and ‘MinTransformSize’ may be the current minimum transformation unit size ‘CurrMinTuSize’ that can be determined in the current coding unit.

According to an exemplary embodiment, the maximum transformation unit size RootTuSize may vary according to the type of a prediction mode.

For example, if a current prediction mode is an inter mode, then ‘RootTuSize’ may be determined by using Equation (2) below. In Equation (2), ‘MaxTransformSize’ denotes a maximum transformation unit size, and ‘PUSize’ denotes a current prediction unit size.

RootTuSize=min(MaxTransformSize,PUSize) Equation (2)

That is, if the current prediction mode is the inter mode, the transformation unit size ‘RootTuSize’, when the TU size flag is 0, may be a smaller value from among the maximum transformation unit size and the current prediction unit size.

If a prediction mode of a current partition unit is an intra mode, ‘RootTuSize’ may be determined by using Equation (3) below. In Equation (3), ‘PartitionSize’ denotes the size of the current partition unit.

RootTuSize=min(MaxTransformSize,PartitionSize) Equation (3)

That is, if the current prediction mode is the intra mode, the transformation unit size ‘RootTuSize’ when the TU size flag is 0 may be a smaller value from among the maximum transformation unit size and the size of the current partition unit.

However, the current maximum transformation unit size ‘RootTuSize’ that varies according to the type of a prediction mode in a partition unit is just an example and the exemplary embodiments are not limited thereto.

The maximum coding unit including coding units having a tree structure described with reference to FIGS. 1 through 13 above may be variously referred to as a coding block tree, a block tree, a root block tree, a coding tree, a coding root, or a tree trunk.

Hereinafter, a 3D video encoding method and a 3D video decoding method based on coding units having a tree structure will be described with reference to FIGS. 14 through 17.

According to an inter-layer encoding method according to an exemplary embodiment, 3D video is classified according to a plurality of layers and encoded. The 3D video includes two or more images according to views.

A single view image may include a texture image and a depth image. The texture image may be an image on which a pixel value is recorded for each YUV color component. The depth image may be an image in which a depth component of an image is expressed as a 2D image.

That is, a base view image may include a base view texture image and a base view depth image. A first additional view image may include a first additional view texture image and a first additional view depth image. A second additional view image may include a second additional view texture image and a second additional view depth image. Hereinafter, for convenience of description, a “base view image” or an “additional view image” may be understood as a “base view texture image and/or a base view depth image” or an “additional view texture image and/or an additional view depth image”.

In a video of the same view, the texture image and the depth image may be classified according to different layers and encoded. According to an exemplary embodiment, among images classified as multiple layers, a base layer image is encoded. The texture image and the depth image of the base view image may be classified according to different layers. One of the base view texture image and the base view depth image may be encoded as the base layer image. The other one of the base view texture image and the base view depth image may be encoded as the additional layer image.

According to an inter-layer encoding apparatus of 3D video that will be described later, the baser layer image may be encoded based on the coding units having the tree structure described with reference to FIGS. 1 through 13 above. That is, the base layer image may be spilt according to maximum coding units, based on completely split coding units among coding units hierarchically split from each of the maximum coding units, a coding mode may be determined, and encoded data may be output.

According to an exemplary embodiment, by referring to encoding information generated by encoding the base layer image that is one of the base view texture image and the base view depth image, the other one of the base view texture image and the base view depth image may be encoded.

An encoding order of the base view texture image and the base view depth image may be switched. A previously encoded image among the base view texture image and the base view depth image may be selected as the base layer image. The other image of the base view texture image and the base view depth image may be prediction encoded based on encoding information of the image selected as the base layer image.

As described with reference to FIGS. 1 through 13 above, an image of video may be spatially split into maximum coding units. Each of the maximum coding units may be split into a plurality of coding units. When it is determined whether each of the coding units is split into smaller coding units, each coding unit may be determined individually and independently from adjacent coding units.

According to an exemplary embodiment, among images classified according to a plurality of layers, the additional layer image may be encoded by referring to an encoding symbol of the base layer image.

The number of additional layers may be plural. The additional layer image may include the base view texture image and the base view depth image that are not encoded as the base layer image. The additional layer image may include a YUV texture image and a depth map image of an additional view image. There may be one or more additional views. Each additional view may be classified according to different layers. In an image of the same additional view, a texture image and a depth image may be classified according to different layers.

Based on coding units having the tree structure of the additional layer image, data having an encoded additional layer image may be output. Encoding information of the base view image may be referred to for encoding the additional layer image.

According to an exemplary embodiment, at least one among the additional view texture image and the additional view depth image may be encoded by referring to encoding information of the base view texture image.

According to an exemplary embodiment, at least one among the additional view texture image and the additional view depth image may be encoded by referring to encoding information of the base view depth image.

According to an exemplary embodiment, prediction encoding may be performed on a texture image and a depth image of the same additional view. One of the additional view texture image and the additional view depth image may be encoded in advance. By referring to encoding information generated by encoding one of the additional view texture image and the additional view depth image in advance, the other one of the additional view texture image and the additional view depth image may be encoded. In this case, an encoding order of the additional view texture image and the additional view depth image may also be switched. The other image may be prediction encoded based on encoding information of one of the additional view texture image and the additional view depth image that is encoded in advance.

Therefore, by referring to the encoding information generated by encoding at least one among the base view texture image and the base view depth image and at least one among the additional view texture image and the additional view depth image, the other image of the additional view texture image and the additional view depth image may be prediction encoded.

According to an exemplary embodiment, an encoding mode of the base layer image and a prediction value thereof may be output. Data encoded by encoding the base layer image for each maximum coding unit based on the coding unit having the tree structure may be output.

When the base layer image is the base view texture image or the base view depth image, and the additional layer image is the additional view texture image or the additional view depth image, inter-layer prediction may be, e.g., inter-view prediction between different views. However, when the base layer image is a predetermined view texture (depth) image, and the additional layer image is a predetermined view depth (texture) image, inter-layer prediction may be prediction between a texture image and a depth image with same views.

Although only an encoding process is described above, these features also apply to a decoding process. That is, the encoding mode of the base layer image and the prediction value thereof may be parsed, and an encoding mode of the additional layer image and a prediction value thereof may be induced by using the parsed encoding mode of the base layer image and prediction value thereof.

For example, when the encoding information of the base view texture image that is the base layer image is parsed, at least one among the additional view texture image and the additional view depth image may be decoded by referring to the parsed encoding information of the base view texture image.

According to an exemplary embodiment, when the encoding information of the base view depth image that is the base layer image is parsed, at least one among the additional view texture image and the additional view depth image may be decoded by referring to the parsed encoding information of the base view depth image.

The base layer image and the additional layer image may be restored according to inter-layer prediction between the base layer image and the additional layer image.

FIG. 14 is a block diagram of a 3D encoding system using inter-layer prediction according to an exemplary embodiment.

The inter-layer encoding system 1600 includes a base layer encoding end 1610, an additional layer encoding end 1660, and an inter-layer prediction end 1650 between the base layer encoding end 1610 and the additional layer encoding end 1660.

According to an inter-layer encoding method, a multi-view video may be classified into layer images of multi-layers according to views and a texture image and a depth image.

The inter-layer encoding apparatus 1600 according to an exemplary embodiment classifies and encodes the multi-view video according to a plurality of layers.

A single view image may include a texture image and a depth image. The texture image may be an image on which a pixel value is recorded for each YUV color component. The depth image may be an image in which a depth component of an image is expressed as a 2D image.

That is, a base view image may include a base view texture image and a base view depth image. A first additional view image may include a first additional view texture image and a first additional view depth image. A second additional view image may include a second additional view texture image and a second additional view depth image. Hereinafter, for convenience of description, a “base view image” and an “additional view image” may be understood as a “base view texture image and/or a base view depth image” and an “additional view texture image and/or an additional view depth image”, respectively.

In a video of the same view, the texture image and the depth image may be classified according to different layers and encoded. The base layer encoding end 1610 according to an exemplary embodiment encodes a base layer image, among images classified as multiple layers. The texture image and the depth image of the base view image may be classified according to different layers. One of the base view texture image and the base view depth image may be encoded as the base layer image. The other one of the base view texture image and the base view depth image may be encoded as the additional layer image.

The inter-layer encoding apparatus 1600 according to an exemplary embodiment may encode the base layer image based on the coding units having the tree structure described with reference to FIGS. 1 through 13 above. That is, the base layer encoding end 1610 may split the base layer image according to maximum coding units, based on completely split coding units among coding units hierarchically split from each of the maximum coding units, determine a coding mode, and output encoded data.

The additional layer encoding end 1660 according to an exemplary embodiment may, by referring to encoding information generated by encoding the base layer image that is one of the base view texture image and the base view depth image, encode the other one of the base view texture image and the base view depth image.

Hereinafter, for convenience of description, a case where the inter-layer encoding system 1600 of the multi-view video classifies and encodes the base view texture image as the base layer image, and the base view depth image, the additional view texture image, or the additional view depth image as the additional layer image, will now be described in detail.

The base layer encoding end 1610 receives a base layer image sequence and encodes each image of the base layer image sequence. The additional layer encoding end 1660 receives an additional layer image sequence and encodes each image of the additional layer image sequence. Redundant operations performed by the base layer encoding end 1610 and the additional layer encoding end 1660 will be concurrently described later.

Block splitters 1618 and 1668 split the input images (the low resolution image and the high resolution image) into maximum coding units, coding units, prediction units, and transformation units. To encode the coding units output from the block splitters 1618 and 1668, intra prediction or inter prediction may be performed for each prediction unit of the coding units. Prediction switches 1648 and 1698 may perform inter prediction by referring to a previously reconstructed image output from motion compensators 1640 and 1690 or may perform intra prediction by using a neighboring prediction unit of a current prediction unit within a current input image output from intra predictors 1645 and 1695, according to whether a prediction mode of each prediction unit is an intra prediction mode or an inter prediction mode. Residual information may be generated for each prediction unit through inter prediction.

Residual information between the prediction units and peripheral images are input to transformers/quantizers 1620 and 1670 for each prediction unit of the coding units. The transformers/quantizers 1620 and 1670 may perform transformation and quantization for each transformation unit and output quantized transformation coefficients based on transformation units of the coding units.

Scalers/inverse transformers 1625 and 1675 may perform scaling and inverse transformation on the quantized coefficients for each transformation unit of the coding units again and generate residual information of a spatial domain. In a case where the prediction switches 1648 and 1698 are switched into the inter mode, the residual information may be combined with the previous reconstructed image or the neighboring prediction unit so that a reconstructed image including the current prediction unit may be generated and a current reconstructed image may be stored in storage units 1630 and 1680. The current reconstructed image may be transferred to the intra predictors 1645 and 1695 and the motion compensators 1640 and 1690 again according to a prediction mode of a prediction unit that is to be encoded next.

In particular, in the inter mode, in-loop filters 1635 and 1685 may perform at least one among deblocking filtering, a sample adaptive offset (SAO) operation, and adaptive loop filtering (ALF) on the current reconstructed image stored in the storage units 1630 and 1680 for each coding unit. At least one among the deblocking filtering, the SAO operation, and the ALF filtering may be performed on at least one among the coding units, the prediction units included in the coding units, and the transformation units.

The deblocking filtering is filtering for reducing blocking artifacts of data units. The SAO operation is filtering for compensating for a pixel value modified by data encoding and decoding. The ALF filtering is filtering for minimizing a mean squared error (MSE) between a reconstructed image and an original image. Data filtered by the in-loop filters 1635 and 1685 may be transferred to the motion compensators 1640 and 1690 for each prediction unit. To encode the coding unit having a next sequence that is output from the block splitters 1618 and 1668 again, residual information between the current reconstructed image and the next coding unit that are output from the motion compensators 1618 and 1668 and the block splitters 1618 and 1668 may be generated.

The above-described encoding operation for each coding unit of the input images may be repeatedly performed in the same manner as described above.

The additional layer encoding end 1660 may refer to the reconstructed image stored in the storage unit 1630 of the base layer encoding end 1610 for the inter-layer prediction. An encoding control unit 1615 of the base layer encoding end 1610 may control the storage unit 1630 of the base layer encoding end 1610 and transfer the reconstructed image of the base layer encoding end 1610 to the additional layer encoding end 1660. The in-loop filter 1655 of the inter-layer prediction end 1650 may perform at least one of the deblocking filtering, the SAO filtering, and the ALF filtering on a base layer reconstructed image output from the storage unit 1630 of the base layer encoding end 1610. In a case where a base layer image and an additional layer image have different resolutions, the inter-layer prediction end 1650 may up-sample and transfer a base layer reconstructed image to the additional layer encoding end 1660. In a case where inter-layer prediction is performed according to control of the switch 1698 of the additional layer encoding end 1660, inter-layer prediction of the additional layer image may be performed by referring to the base layer reconstructed image transferred through the inter-layer prediction end 1650.

For image encoding, diverse coding modes may be set for the coding units, prediction units, and transformation units. For example, a depth or a split flag may be set as a coding mode for the coding units. A prediction mode, a partition type, an intra direction flag, or a reference list flag may be set as a coding mode for the prediction units. The transformation depth or the split flag may be set as a coding mode of the transformation units.

The base layer encoding end 1610 may determine a coding depth, a prediction mode, a partition type, an intra direction and reference list, and a transformation depth having the highest coding efficiency according to a result obtained by performing encoding by applying diverse depths for the coding units, diverse prediction modes for the prediction units, diverse partition types, diverse intra directions, diverse reference lists, and diverse transformation depths for the transformation units.

The encoding control unit 1615 of the base layer encoding end 1610 may control diverse coding modes to be appropriately applied to operations of elements. For scalable video encoding of the additional layer encoding end 1660, the encoding control unit 1615 may control the additional layer encoding end 1660 to determine a coding mode or residual information by referring to the encoding result of the base layer encoding end 1610.

For example, the additional layer encoding end 1660 may use the coding mode of the base layer encoding end 1610 as a coding mode of the additional layer image or may determine the coding mode of the additional layer image by referring to the coding mode of the base layer encoding end 1610. The encoding control unit 1615 of the base layer encoding end 1610 may control a control signal of the encoding control unit 1615 of the base layer encoding end 1610 and, to determine a current coding mode of the additional layer encoding end 1660, may use the current coding mode based on the coding mode of the base layer encoding end 1610.

Similarly to the inter-layer encoding system 1600 of the multi-view video according to the inter-layer prediction method of FIG. 14, an inter-layer decoding system of the multi-view video according to the inter-layer prediction method may be also implemented. That is, the inter-layer decoding system of the multi-view video may receive a base layer bitstream and an additional layer bitstream.

A base layer decoding end of the inter-layer decoding system may decode the base layer bitstream to generate base layer reconstructed images. An additional layer decoding end of the inter-layer decoding system of the multi-view video may decode the additional layer bitstream to generate additional layer reconstructed images by using the base layer reconstructed images and a parsed encoding symbol.

According to an exemplary embodiment, base view texture images may be reconstructed as the base layer reconstructed images, and base view depth images may be reconstructed as the additional layer reconstructed images. According to another exemplary embodiment, the base view texture images may be reconstructed as the base layer reconstructed images, and additional view texture images may be reconstructed as the additional layer reconstructed images. According to another exemplary embodiment, the base view depth images may be reconstructed as the base layer reconstructed images, and additional view depth images may be reconstructed as the additional layer reconstructed images.

According to another exemplary embodiment, the base view depth images may be reconstructed as the base layer reconstructed images, and the additional view texture images may be reconstructed as the additional layer reconstructed images.

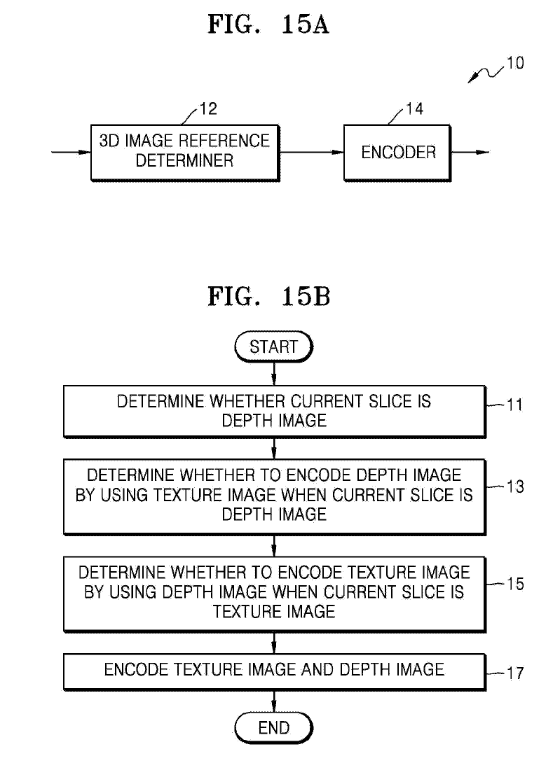

Hereinafter, a 3D video encoding process using inter-layer prediction and a process of transmitting information regarding the inter-layer prediction will now be described in detail with reference to FIGS. 15A and 15B. For convenience of description, a case where a texture image and a depth image of a current view image are encoded as a base layer image and an additional layer image will now be described in detail.

FIG. 15A is a block diagram of a 3D video encoding apparatus 10 according to an exemplary embodiment.

The 3D video encoding apparatus 10 according to an exemplary embodiment includes a 3D image reference determiner 12 and an encoder 14.

The 3D video encoding apparatus 10 according to an exemplary embodiment encodes current view images of a 3D video. The current view images may be one of picture sequences, pictures, and slices. One picture may include one or more independent slices. When one picture includes two or more slices, at least one independent slice and other dependent slices may be included in one picture.

The 3D image reference determiner 12 according to an exemplary embodiment may determine whether a current slice is a depth image among a texture image and the depth image of the same view 3D image.

When the current slice is the depth image, the 3D image reference determiner 12 according to an exemplary embodiment may determine whether to encode the depth image by using the texture image that is encoded prior to the current slice.

When the current slice is the texture image, the 3D image reference determiner 12 according to an exemplary embodiment may determine whether to encode the texture image by using the depth image that is encoded prior to the current slice.

The encoder 14 according to an exemplary embodiment may encode the texture image and the depth image based on a use relationship between the texture image and the depth image determined by the 3D image reference determiner 12.

FIG. 15B is a flowchart of a 3D video encoding method according to an exemplary embodiment. The 3D video encoding method performed by the 3D video encoding apparatus 10 described with reference to FIG. 15A will now be described in detail.

In operation 11, the 3D video encoding apparatus 10 determines whether a current slice is a depth image among a texture image and the depth image of the same view 3D image. If the current slice is determined as the depth image in operation 11, operation 13 is performed. If the current slice is not determined as the depth image in operation 11, operation 15 is performed.

When the current slice is the depth image, in operation 13, the 3D video encoding apparatus 10 may determine whether to encode the depth image by using the texture image that is encoded prior to the current slice.

When the current slice is the texture image, in operation 15, the 3D video encoding apparatus 10 may determine whether to encode the texture image by using the depth image that is encoded prior to the current slice.

In operation 17, the 3D video encoding apparatus 10 may encode the texture image and the depth image based on a use relationship between the texture image and the depth image determined in operation 13 or 15.

When the current slice is the depth image, and the depth image is encoded by using the texture image, in operation 13, the 3D video encoding apparatus 10 may encode the depth image by using the previously encoded texture image of the same view.

When the current slice is the texture image, and the texture image is encoded by using the depth image, in operation 15, the 3D video encoding apparatus 10 may encode the texture image by using the previously encoded depth image of the same view.

The 3D video encoding apparatus 10 according to an exemplary embodiment may generate a slice header including information regarding inter-layer prediction, e.g., information regarding a prediction relationship between the texture image and the depth image.

If it is determined that the current slice is the depth image in operation 11, the 3D video encoding apparatus 10 may include first information indicating that the current slice is the depth image in the slice header.

When the current slice is the depth image, and the depth image is encoded by using the texture image in operation 13, the 3D video encoding apparatus 10 may generate a slice header including second information indicating that the depth image is encoded by using the previously encoded texture image and the first information indicating that the current slice is the depth image.

When the current slice is the depth image, and the depth image is encoded by not using the texture image, the 3D video encoding apparatus 10 may encode the depth image independently from the texture image of the same view. In this case, the 3D video encoding apparatus 10 may generate a slice header including second information indicating that the depth image is encoded by not using the previously encoded texture image and the first information indicating that the current slice is the depth image.

When the current slice is the texture image, and the texture image is encoded by using the previously encoded depth image in operation 15, the 3D video encoding apparatus 10 may generate a slice header including third information indicating that the texture image is encoded by using the previously encoded depth image and the first information indicating that the current slice is not the depth image.

When the current slice is the texture image, and the texture image is encoded by not using the depth image, the 3D video encoding apparatus 10 may encode the texture image independently from the depth image of the same view. In this case, the 3D video encoding apparatus 10 may generate a slice header including the third information indicating that the texture image is encoded by not using the previously encoded depth image and the first information indicating that the current slice is not the depth image.

According to an exemplary embodiment, when the current slice is the depth image, the 3D video encoding apparatus 10 may determine whether to estimate slice related information of the depth image by referring to slice related information of the texture image. If the 3D video encoding apparatus 10 determines to estimate the slice related information of the depth image by referring to the slice related information of the texture image, the 3D video encoding apparatus 10 may encode the depth image by using the slice related information of the texture image without having to separately determine the slice related information of the depth image.

In this case, the 3D video encoding apparatus 10 may generate a slice header including fourth information indicating whether to determine the slice related information of the depth image by referring to the slice related information of the texture image and the first information indicating that the current slice is the depth image. If the 3D video encoding apparatus 10 includes the fourth information indicating whether to determine the slice related information of the depth image in the slice header, redundant slice related information between the depth image and the texture image may not be included in a slice header of the depth image.

When the 3D video encoding apparatus 10 according to an exemplary embodiment uses the slice related information of the texture image to encode the depth image, slice related information that may be referred to from a slice header of the texture image may include at least one among information indicating a decoded picture buffer (DPB) state of a reference picture selection (RPS) of the depth image, a reference index, and a slice quantization parameter (QP) differential value.

Therefore, if the 3D video encoding apparatus 10 according to an exemplary embodiment does not refer to the slice related information of the texture image when encoding the depth image, for the current slice that is the depth image, the 3D video encoding apparatus 10 may generate a slice header further including at least one among the information indicating the DPB state of the RPS of the depth image, the reference index, and the slice QP differential value.

As described above, the 3D video encoding apparatus 10 according to an exemplary embodiment may encode the texture image and the depth image by using coding units having a tree structure. Thus, the texture image and the depth image according to an exemplary embodiment may be split into spatially maximum coding units. Each of the maximum coding units may be split into a plurality of coding units. Depths of the coding units increase when the maximum coding units are split according to steps. It may be determined whether to further split each of the coding units for each depth independently from the other coding units. Thus, it may be determined whether each coding unit may be split into smaller coding units independently from adjacent coding units.

The 3D video encoding apparatus 10 according to an exemplary embodiment may output encoding symbols determined in a coding unit that is no longer split. The 3D video encoding apparatus 10 may output the slice header along with finally determined encoding information.

Accordingly, the 3D video encoding apparatus 10 may transmit a bitstream including the encoding symbols and the slice header.

For convenience of description, the case where the 3D video encoding apparatus 10 performs prediction encoding on the texture image and the depth image of the same view is described above. However, an operating principle of the 3D video encoding apparatus 10 may be applied to a case where prediction encoding is performed on a base view image and an additional view image.

In this case, the slice header may include at least one among fifth information indicating whether a current image is the additional view image, when the current image is or is not the additional view image, sixth information indicating whether to encode the additional view image by using a previously encoded base view image, when the current image is the additional view image, seventh information indicating whether to use slice header information of the previously encoded base view image, when the current image is the base view image, and eighth information indicating whether to encode the base view image by using a previously encoded additional view image.

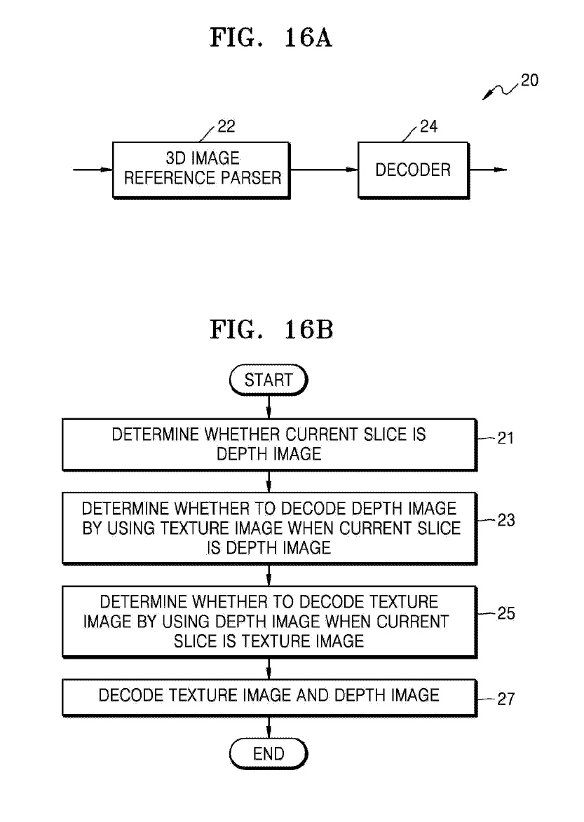

FIG. 16A is a block diagram of a 3D video decoding apparatus 20 according to an exemplary embodiment.

The 3D video decoding apparatus 20 according to an exemplary embodiment includes a 3D image reference parser 22 and a decoder 24.

The 3D video decoding apparatus 20 according to an exemplary embodiment receives a bitstream including 3D image encoded symbols. The 3D video decoding apparatus 20 may parse a slice header and encoding symbols of a slice from the received bitstream.

The 3D video decoding apparatus 20 according to an exemplary embodiment may parse information regarding inter-layer prediction for a current slice, e.g., information regarding a prediction relationship between a texture image and a depth image, from the slice header.

As described above, the 3D video decoding apparatus 20 according to an exemplary embodiment may decode the texture image and the depth image by using coding units having a tree structure. The 3D video decoding apparatus 20 according to an exemplary embodiment may parse encoding symbols determined in a coding unit that is no longer split. The encoding symbols may be parsed from the slice header. The 3D image reference parser 22 according to an exemplary embodiment may determine whether the current slice is a depth image among a texture image and the depth image of a 3D image of the same view, based on the information parsed from the slice header.

When the current slice is the depth image, the 3D image reference parser 22 according to an exemplary embodiment may determine whether to decode the depth image by using the texture image that is decoded prior to the current slice.

When the current slice is the texture image, the 3D image reference parser 22 according to an exemplary embodiment may determine whether to decode the texture image by using the depth image that is decoded prior to the current slice.

The decoder 24 according to an exemplary embodiment may decode the depth image and the texture image, based on a use relationship between the texture image and the depth image determined by the 3D image reference parser 22.

FIG. 16B is a flowchart of a 3D video decoding method according to an exemplary embodiment. The 3D video decoding method performed by the 3D video decoding apparatus 20 described with reference to FIG. 16A will now be described in detail.

As described above, the 3D video decoding apparatus 20 according to an exemplary embodiment may decode a texture image and a depth image by using coding units having a tree structure.

The 3D video decoding apparatus 20 according to an exemplary embodiment may parse encoding symbols determined in a coding unit that is no longer split. The encoding symbols may be parsed from the slice header.

In operation 21, the 3D video decoding apparatus 20 determines whether a current slice is a depth image among a texture image and the depth image of the same view 3D image.

In operation 21, the 3D video decoding apparatus 20 may parse first information indicating whether the current slice is the depth image from a slice header for the current slice. If the current slice is determined as the depth image based on the first information, operation 23 may be performed. If the current slice is not determined as the depth image based on the first information, operation 25 may be performed.

When the current slice is the depth image, in operation 23, the 3D video decoding apparatus 20 may determine whether to decode the depth image by using the texture image that is encoded prior to the current slice.

When the current slice is determined as the depth image based on the first information in operation 21, in operation 23, the 3D video decoding apparatus 20 may further parse second information indicating whether to decode the depth image by using the previously encoded texture image from the slice header for the current slice.

When the current slice is the texture image, in operation 25, the 3D video decoding apparatus 20 may determine whether to decode the texture image by using the depth image that is decoded prior to the current slice.

When the current slice is not determined as the depth image based on the first information in operation 21, in operation 25, the 3D video decoding apparatus 20 may further parse third information indicating whether to decode the texture image by using the previously encoded depth image from the slice header for the current slice.

In operation 27, the 3D video decoding apparatus 20 may decode the texture image and the depth image based on a use relationship between the texture image and the depth image determined in operation 23 or 25.

If the depth image is decoded by using the texture image based on the second information in operation 23, in operation 27, the 3D video decoding apparatus 20 may decode the depth image by using the previously decoded texture image.

If the depth image is decoded by not using the texture image based on the second information, in operation 27, the 3D video decoding apparatus 20 may decode the depth image by using encoding symbols parsed for the depth image independently from the texture image.

If the texture image is decoded by using the depth image based on the third information in operation 25, in operation 27, the 3D video decoding apparatus 20 may decode the texture image by using the previously decoded depth image.

If the texture image is not decoded by using the depth image based on the third information, in operation 27, the 3D video decoding apparatus 20 may decode the texture image by using encoding symbols parsed for the texture image independently from the depth image.

In operation 23, the 3D video decoding apparatus 20 may further parse fourth information indicating whether to determine slice related information of the depth image by referring to slice related information of the texture image from the slice header.

In operation 27, the 3D video decoding apparatus 20 may determine whether to determine the slice related information of the depth image by referring to the slice related information of the texture image by parsing the fourth information from the slice header. In this case, the 3D video decoding apparatus 20 may decode the depth image by using the slice related information of the texture image according to the determination based on the fourth information.

In operation 27, the 3D video decoding apparatus 20 may read that the slice related information of the texture image is not referred to for slice decoding of the depth image based on the third information. In this case, in operation 27, the 3D video decoding apparatus 20 may parse at least one among information indicating a DPB state of an RPS of the depth image, a reference index, and a slice QP differential value from the slice header for the current slice.

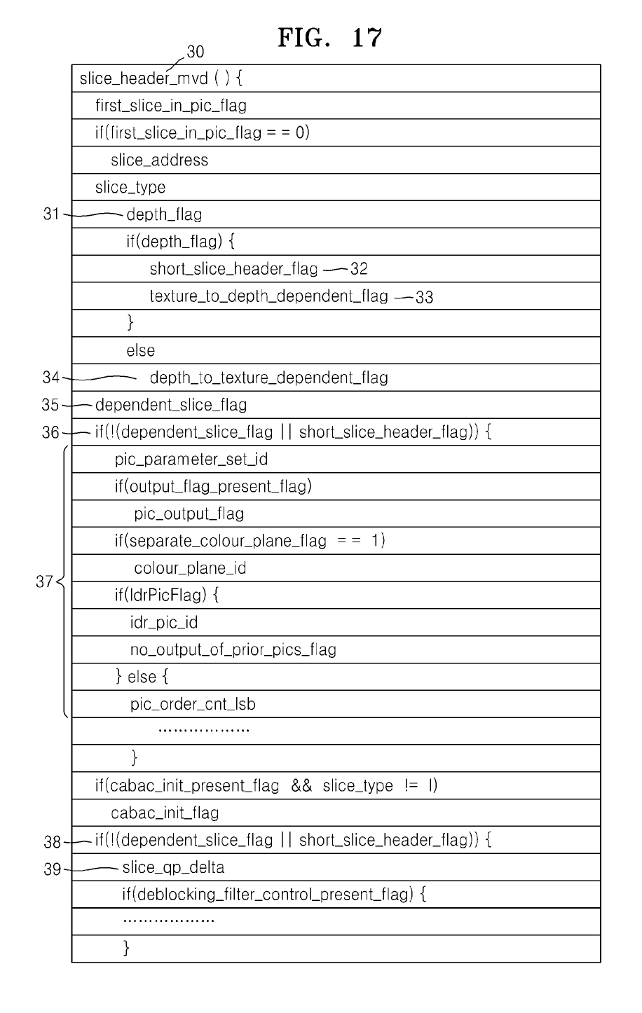

FIG. 17 shows a syntax of a slice header 30 according to an exemplary embodiment.

The 3D video encoding apparatus 10 according to an exemplary embodiment may generate the slice header 30 having recorded thereon encoding related information that is to be commonly used with respect to blocks in a current slice when encoding the current slice, for each slice. The 3D video encoding apparatus 10 may transmit the slice header 30 in a bitstream form and encoding symbols generated by encoding slices.

The slice header 30 according to an exemplary embodiment is a slice header for a multi-view plus depth format used to encode each view image of a 3D video for each view, divide each view image into a texture image and a depth image, and predict between the texture image and the depth image. Thus, the slice header 30 records the encoding related information necessary for decoding the current slice through inter prediction between the texture image and the depth image.

The 3D video encoding apparatus 10 according to an exemplary embodiment includes “depth_flag” 31 that is information indicating whether the current slice is the depth image in the slice header 30.

If “depth_flag” 31 indicates that the current slice is the depth image, the slice header 30 may include “short_slice_header_flag” 32 that is information indicating whether a slice header of a current depth image refers to a slice header of the texture image of the same view and “texture_to_depth_dependent_flag” 33 that is information indicating whether to encode the current depth image by using an encoding symbol of the texture image of the same view that is encoded prior to the current depth image.

If “depth_flag” 31 indicates that the current slice is not the depth image, the slice header 30 may include “depth_to_texture_dependent_flag” 34 that is information indicating whether to encode a current texture image by using an encoding symbol of a depth image of the same view that is encoded prior to the current texture image.

The slice header 30 according to an exemplary embodiment includes “dependent_slice_flag” 35 that is information indicating whether the current slice is a dependent slice.

When “dependent_slice_flag” 35 indicates that the current slice is not the dependent slice, and “short_slice_header_flag” 32 indicates that the slice header of the current depth image does not refer to the slice header of the texture image of the same view 36, the slice header 30 according to an exemplary embodiment may include encoding related information 37 directly set for the current slice that is the depth image. For example, the encoding related information 37 of the slice header 30 may include “colour_plane_id” that is information indicating whether the current slice is a Y plane, a Cr plane, or a Cb plane among color planes, “idr_pic_id” that is instantaneous decoding refresh (IDR) picture number information when the current slice is an IDR image, “no_output_of_prior_pics_flag” that is information indicating the number of previously decoded images that are stored in a decoding picture buffer, and “pic_order_cnt_lsb” that is information regarding numbers of reference pictures that are stored in the decoding picture buffer.

When “dependent_slice_flag” 35 indicates that the current slice is not the dependent slice, and “short_slice_header_flag” 32 indicates that the slice header of the current depth image does not refer to the slice header of the texture image of the same view 38, the slice header 30 according to an exemplary embodiment may further include “slice_qp_delta” 39 that is differential value information of a QP for quantization of the current slice.

The 3D video decoding apparatus 20 according to an exemplary embodiment may receive a bitstream and parse a slice header for each slice and encoding symbols. The 3D video decoding apparatus 20 may read and use the encoding related information that is to be commonly used with respect to blocks in the current slice from the slice header 30 to decode the current slice.

The 3D video decoding apparatus 20 may parse “depth_flag” 31 from the slice header 30 to determine whether the current slice is the depth image.

If “depth_flag” 31 indicates that the current slice is the depth image, the 3D video decoding apparatus 20 may parse “short_slice_header_flag” 32 from the slice header 30 to determine whether the slice header of the current depth image refers to the slice header of the texture image of the same view.

If “depth_flag” 31 indicates that the current slice is the depth image, the 3D video decoding apparatus 20 may parse “texture_to_depth_dependent_flag” 33 from the slice header 30 to determine whether to decode the current depth image by using encoding symbols of the texture image of the same view that is decoded prior to the current depth image.

If “depth_flag” 31 indicates that the current slice is not the depth image, the 3D video decoding apparatus 20 may not need to parse “short_slice_headerflag” 32 and “texture_to_depth_dependent_flag” 33.

If “depth_flag” 31 indicates that the current slice is not the depth image, the 3D video decoding apparatus 20 may parse “depth_to_texture_dependent_flag” 34 from the slice header 30 to determine whether to encode the current texture image by using encoding symbols of the depth image of the same view that is decoded prior to the current texture image.

The 3D video decoding apparatus 20 may parse “dependent_slice_flag” 35 to determine whether the current slice is the dependent slice.

When “dependent_slice_flag” 35 indicates that the current slice is not the dependent slice, and “short_slice_header_flag” 32 indicates that the slice header of the current depth image does not refer to the slice header of the texture image of the same view 36, the 3D video decoding apparatus 20 may parse the encoding related information 37 directly set for the current slice that is the depth image from the slice header 30. For example, the 3D video decoding apparatus 20 may parse “colour_plane_id” from the slice header 30 to determine whether the current slice is the Y plane, the Cr plane, or the Cb plane among the color planes. “idr_pic_id”, “no_output_of_prior_picsf lag”, and “pic_order_cnt_lsb” may be parsed from the slice header 30.

When the current slice is the IDR image, the IDR picture number information may be read from “idr_pic_id”. The number of previously decoded images that are stored in the decoding picture buffer may be read from “no_output_of_prior_pics_flag”. The numbers of the reference pictures stored in the decoding picture buffer may be read from “pic_order_cnt_lsb”.

When “dependent_slice_flag” 35 indicates that the current slice is not the dependent slice, and “short_slice_header_flag” 32 indicates that the slice header of the current depth image does not refer to the slice header of the texture image of the same view 38, the 3D video decoding apparatus 20 may parse “slice_qp_delta” 39 from the slice header 30 to read the differential value information of the QP for quantization of the current slice.

However, when “dependent_slice_flag” 35 indicates that the current slice is the dependent slice, the 3D video decoding apparatus 20 may decode the current slice by using slice related information included in a slice header of an independent slice preceding the current slice, without having to parse the slice related information from the slice header 30. When “short_slice_header_flag” 32 indicates that the slice header of the current depth image refers to the slice header of the texture image of the same view, the 3D video decoding apparatus 20 may decode the current slice by using slice related information included in a slice header of the texture image preceding the current slice, without having to parse the slice related information from the slice header 30.

The 3D video decoding apparatus 20 according to an exemplary embodiment may decode the current slice based on an encoding mode read from various types of slice related information parsed from the slice header 30.

For example, if the encoding symbol of the previously decoded texture image of the same view is determined to be used to decode the current depth image from “texture_to_depth_dependent_flag” 33, the 3D video decoding apparatus 20 according to an exemplary embodiment may decode the current depth image by using the encoding symbol of the texture image.

If the encoding symbol of the previously decoded texture image of the same view is determined not to be used to decode the current depth image from “texture_to_depth_dependent_flag” 33, the 3D video decoding apparatus 20 according to an exemplary embodiment may decode the current depth image independently from the texture image.

If the encoding symbol of the previously decoded depth image of the same view is determined to be used to decode the current texture image from “depth_to_texture_dependent_flag” 34, the 3D video decoding apparatus 20 according to an exemplary embodiment may decode the current texture image by using the encoding symbol of the depth image.

If the encoding symbol of the previously decoded depth image of the same view is determined not to be used to decode the current texture image from “depth_to_texture_dependent_flag” 34, the 3D video decoding apparatus 20 according to an exemplary embodiment may decode the current texture image independently from the depth image.

The 3D video decoding apparatus 20 according to an exemplary embodiment may decode the current slice by using various types of slice related information that are read from the slice header 30 or are inferred from a slice header of a previous texture image, e.g., “colour_plane_id”, “idr_pic_id”, “no_output_of_prior_pics_flag”, “pic_order_cnt_lsb”, and “slice_qp_delta” 39.

The 3D video encoding apparatus 10 according to an exemplary embodiment encodes each picture, each slice, and each block of the 3D video while encoding the texture image and the depth image of the 3D video. Such encoding symbols and encoding mode information may be transmitted in the form of a bitstream. The bitstream may include encoding mode information used in each block in a block unit and encoding resultant symbols.

An SPS having recorded thereon default encoding related information used in a current sequence for each picture sequence is transmitted during an encoding process. A PPS having recorded thereon default encoding related information used in a current picture for each picture is transmitted during the encoding process. A slice header having recorded thereon default encoding related information used in a current slice for each slice is transmitted during the encoding process.

When the texture image and the depth image of the same view are encoded by being referred to each other, the 3D video encoding apparatus 10 according to an exemplary embodiment may record 3D image reference information indicating whether the current slice is the depth image referring to the previously decoded texture image or the texture image referring to the previously decoded depth image in the slice header. Accordingly, the 3D video decoding apparatus 20 may accurately and efficiently decode a remaining image by referring to the texture image or the depth image of the same view by using the 3D image reference information parsed from the slice header.

In particular, a great amount of data may be required to transmit the slice header since the slice header is transmitted for each slice. Thus, when the texture image and the depth image of the same view are encoded by being referred to each other, the 3D video encoding apparatus 10 according to an exemplary embodiment may omit redundant information between the slice header of the depth image and the slice header of the texture image from the slice header of the depth image.

The 3D video encoding apparatus 10 transmits slice header reference information indicating whether to refer to the slice header of the depth image and the slice header of the texture image via the slice header, and thus, the 3D video decoding apparatus 20 may determine whether to refer to the slice header of the texture image to reconstruct the slice header of the depth image by using the slice header reference information parsed from the slice header. Thus, the slide header of the texture image or the depth image of the same view may be accurately and efficiently reconstructed.

The 3D video encoding apparatus 10 according to another exemplary embodiment may use luma related encoding information as chroma related encoding mode information to encode a chroma component of the current slice that is the depth image. Thus, the slice header of the depth image may not include a chroma related syntax. In this case, when the chroma related syntax is not parsed from a slice header of the chroma component, the 3D video encoding apparatus 10 according to another exemplary embodiment may decode symbols of the chroma component by using a syntax recorded onto a slice header of a luma component.

With respect to FIG. 17, it is described above in detail that “depth_flag” 31 that is the information indicating whether the current slice is the depth image, “texture_to_depth_dependent_flag” 33 that is the information indicating whether to decode the current depth image by using the encoding symbol of the previously decoded texture image of the same view, and “depth_to_texture_dependent_flag” 34 that is the information indicating whether to decode the current texture image by using the encoding symbol of the previously decoded depth image, are signaled through the slice header 30.

However, the information indicating whether the current slice is the depth image, such as “depth_flag” 31 according to an exemplary embodiment, may also be signaled for each of an SPS, a PSS, or a network abstract layer (NAL) unit header.

For example, the SPS may signal information indicating whether a current picture sequence is a sequence for all depth images. According to another exemplary embodiment, the PPS may signal information indicating whether a current picture is the depth image. According to another exemplary embodiment, the NAL unit header may signal information indicating whether a current NAL unit is the depth image.

The information indicating whether a current texture slice/depth slice uses an encoding symbol of a previously decoded depth slice/texture slice of the same view, such as “texture_to_depth_dependent_flag” 33 and “depth_to_texture_dependent_flag” 34 according to an exemplary embodiment, may be signaled for each of the SPS, the PPS, an adaptation parameter set (APS), an access unit delimiter (AUD), or a supplement enhancement information (SEI) message.

For example, the SPS may signal information indicating whether a current texture picture sequence/depth picture sequence uses an encoding symbol of a previously decoded depth picture sequence/texture picture sequence of the same view. According to another exemplary embodiment, the PPS may signal information indicating whether a current texture picture/depth picture uses an encoding symbol of a previously decoded depth picture/texture picture of the same view. According to another exemplary embodiment, the AUD may signal information indicating whether a current texture access unit/depth access unit uses an encoding symbol of a previously decoded depth access unit/texture access unit of the same view.

Video encoding and decoding according to inter prediction of the texture image and the depth image of the same view are described with reference to FIGS. 15A through 17. However, as described above, inter prediction between different view images may be possible. For example, prediction encoding is performed on a base view image and an additional view image so that information indicating whether a current slice is the additional view image, information indicating whether to decode the additional view image by using an encoding symbol of the base view image, information indicating whether to decode the base view image by using an encoding symbol of the additional view image, information indicating whether to reconstruct a slice header of the additional view image by referring to a slice header of the base view image, etc., may be recorded on a slice header and signaled.

For convenience of description, a multi-view video encoding method, a multi-view video decoding method, or a video encoding method according to the multi-view video encoding method described with reference to FIGS. 1 through 17 may be collectively referred to as a “video encoding method according to exemplary embodiments”. In addition, the multi-view video decoding method or a video decoding method according to the multi-view video decoding method described with reference to FIGS. 1 through 17 may be referred to as a “video decoding method according to exemplary embodiments”.

A video encoding apparatus including the 3D video encoding apparatus 10 of a multi-view video, the video encoding apparatus 100, or the image encoder 400 described with reference to FIGS. 1 through 17 may be referred to as a “video encoding apparatus according to exemplary embodiments”. In addition, a video decoding apparatus including the 3D video decoding apparatus 20, the video decoding apparatus 200, or the image decoder 500 described above with reference to FIGS. 1 through 17 may be referred to as a “video decoding apparatus according to exemplary embodiments”.

A computer readable recording medium storing a program, e.g., a disc 26000, according to an exemplary, will now be described in detail.

FIG. 18 illustrates a physical structure of the disc 26000 that stores a program, according to an exemplary embodiment. The disc 26000 which is a storage medium may be a hard drive, a compact disc-read only memory (CD-ROM) disc, a Blu-ray disc, or a digital versatile disc (DVD). The disc 26000 includes a plurality of concentric tracks Tf each being divided into a specific number of sectors Se in a circumferential direction of the disc 26000. In a specific region of the disc 26000, a program that executes a method of determining a quantization parameter, a video encoding method, and a video decoding method as described above may be assigned and stored.

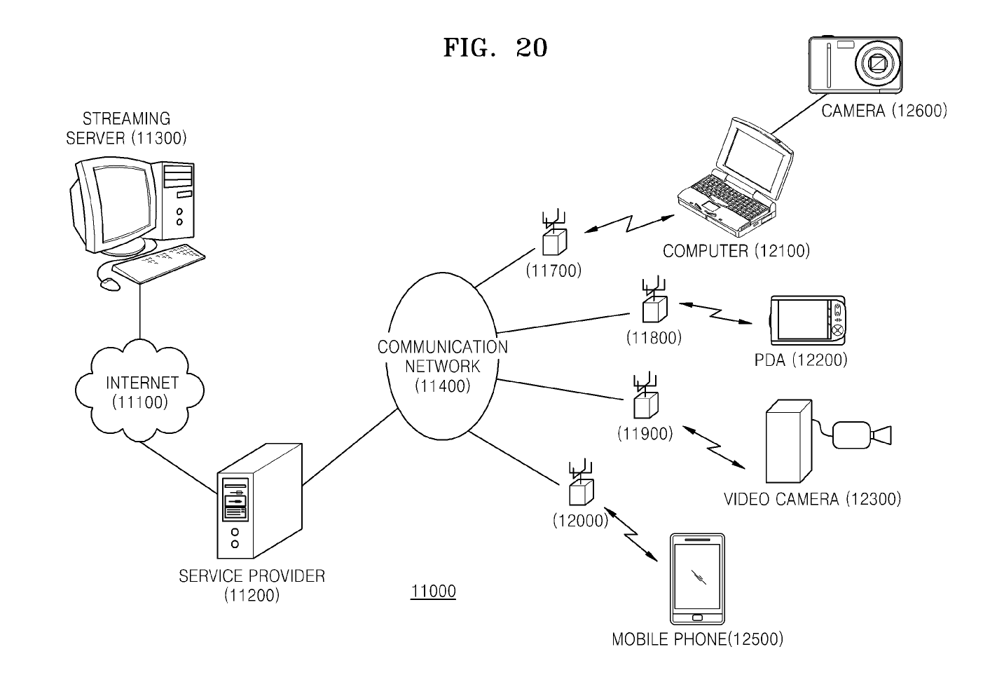

A computer system embodied using a storage medium that stores a program for executing a video encoding method and a video decoding method as described above will now be described with reference to FIG. 19.

FIG. 19 illustrates a disc drive 26800 that records and reads a program by using the disc 26000. A computer system 26700 may store a program that executes at least one of a video encoding method and a video decoding method according to exemplary embodiments, in the disc 26000 via the disc drive 26800. To run the program stored in the disc 26000 in the computer system 26700, the program may be read from the disc 26000 and transmitted to the computer system 26700 by using the disc drive 26800.

The program that executes at least one of a video encoding method and a video decoding method according to exemplary embodiments may be stored not only in the disc 26000 illustrated in FIG. 18 but also in a memory card, a ROM cassette, or a solid state drive (SSD).

A system to which the video encoding method and a video decoding method described above are applied will be described below.

FIG. 20 illustrates an overall structure of a content supply system 11000 that provides a content distribution service. A service area of a communication system is divided into predetermined-sized cells, and wireless base stations 11700, 11800, 11900, and 12000 are installed in these cells, respectively.

The content supply system 11000 includes a plurality of independent devices. For example, the plurality of independent devices, such as a computer 12100, a personal digital assistant (PDA) 12200, a video camera 12300, and a mobile phone 12500, are connected to the Internet 11100 via an internet service provider 11200, a communication network 11400, and the wireless base stations 11700, 11800, 11900, and 12000.

However, the content supply system 11000 is not limited to the configuration illustrated in FIG. 20, and devices may be selectively connected thereto. The plurality of independent devices may be directly connected to the communication network 11400, rather than via the wireless base stations 11700, 11800, 11900, and 12000.

The video camera 12300 is an imaging device, e.g., a digital video camera, which is capable of capturing video images. The mobile phone 12500 may employ at least one communication method from among various protocols, e.g., Personal Digital Communications (PDC), Code Division Multiple Access (CDMA), Wideband-Code Division Multiple Access (W-CDMA), Global System for Mobile Communications (GSM), and Personal Handyphone System (PHS).

The video camera 12300 may be connected to a streaming server 11300 via the wireless base station 11900 and the communication network 11400. The streaming server 11300 allows content received from a user via the video camera 12300 to be streamed via a real-time broadcast. The content received from the video camera 12300 may be encoded using the video camera 12300 or the streaming server 11300. Video data captured by the video camera 12300 may be transmitted to the streaming server 11300 via the computer 12100.

Video data captured by a camera 12600 may also be transmitted to the streaming server 11300 via the computer 12100. The camera 12600 is an imaging device capable of capturing both still images and video images, similar to or the same as a digital camera. The video data captured by the camera 12600 may be encoded using the camera 12600 or the computer 12100. Software that performs encoding and decoding of video may be stored in a computer readable recording medium, e.g., a CD-ROM disc, a floppy disc, a hard disc drive, an SSD, or a memory card, which may be accessible by the computer 12100.

If video data is captured by a camera built into the mobile phone 12500, the video data may be received from the mobile phone 12500.

The video data may also be encoded by a large scale integrated circuit (LSI) system installed in the video camera 12300, the mobile phone 12500, or the camera 12600.

According to an exemplary embodiment, the content supply system 11000 may encode content data recorded by a user using the video camera 12300, the camera 12600, the mobile phone 12500, or another imaging device, e.g., content recorded during a concert, and transmit the encoded content data to the streaming server 11300. The streaming server 11300 may transmit the encoded content data in a type of a streaming content to other clients that request the content data.

The clients are devices capable of decoding the encoded content data, e.g., the computer 12100, the PDA 12200, the video camera 12300, or the mobile phone 12500. Thus, the content supply system 11000 enables the clients to receive and reproduce the encoded content data. Also, the content supply system 11000 enables the clients to receive the encoded content data and decode and reproduce the encoded content data in real time, thereby enabling personal broadcasting.

Encoding and decoding operations of the plurality of independent devices included in the content supply system 11000 may be similar to those of a video encoding apparatus and a video decoding apparatus according to exemplary embodiments.

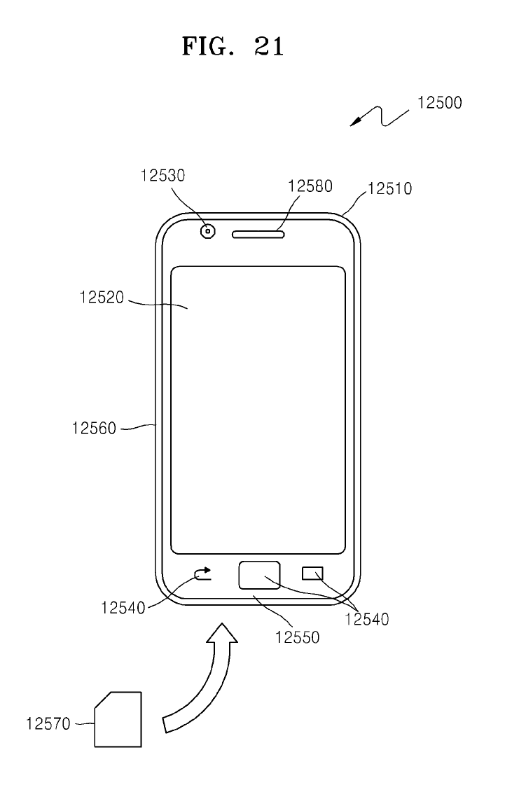

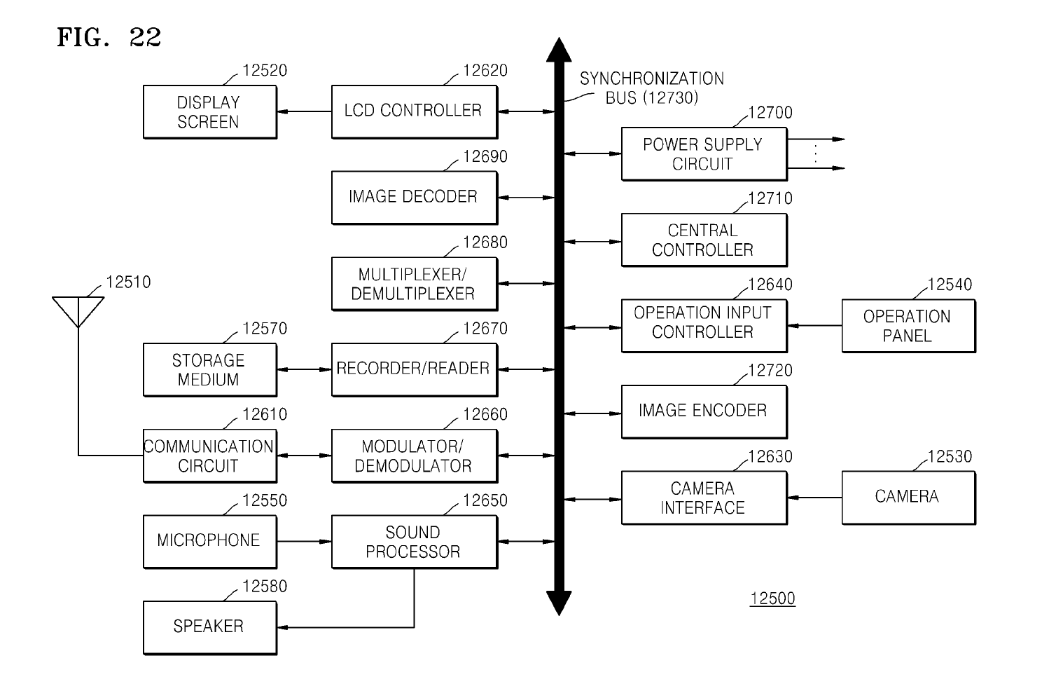

The mobile phone 12500 included in the content supply system 11000 according to an exemplary embodiment will now be described in greater detail with reference to FIGS. 21 and 22.

FIG. 21 illustrates an external structure of a mobile phone 12500 to which a video encoding method and a video decoding method according to exemplary embodiments are applied, according to an exemplary embodiment. The mobile phone 12500 may be a smart phone, the functions of which are not limited and a large part of the functions of which may be changed or expanded.

The mobile phone 12500 includes an internal antenna 12510 via which a radio-frequency (RF) signal may be exchanged with the wireless base station 12000 of FIG. 21, and includes a display screen 12520, e.g., a liquid crystal display (LCD) or an organic light-emitting diodes (OLED) screen, for displaying images captured by a camera 12530 or images that are received via the antenna 12510 and decoded. The smart phone 12510 includes an operation panel 12540 including a control button and a touch panel. If the display screen 12520 is a touch screen, the operation panel 12540 further includes a touch sensing panel of the display screen 12520. The smart phone 12510 includes a speaker 12580 for outputting voice and sound or another type sound output unit, and a microphone 12550 for inputting voice and sound or another type sound input unit. The smart phone 12510 further includes the camera 12530, such as a charge-coupled device (CCD) camera, to capture video and still images. The smart phone 12510 may further include a storage medium 12570 for storing encoded and/or decoded data, e.g., video or still images captured by the camera 12530, received via email, or obtained according to various ways; and a slot 12560 via which the storage medium 12570 is loaded into the mobile phone 12500. The storage medium 12570 may be a flash memory, e.g., a secure digital (SD) card or an electrically erasable and programmable read only memory (EEPROM) included in a plastic case.

FIG. 22 illustrates an internal structure of the mobile phone 12500, according to an exemplary embodiment. To systemically control parts of the mobile phone 12500 including the display screen 12520 and the operation panel 12540, a power supply circuit 12700, an operation input controller 12640, an image encoding unit 12720 (e.g., image encoder), a camera interface 12630, an LCD controller 12620, an image decoding unit 12690 (e.g., image decoder), a multiplexer/demultiplexer 12680, a recording/reading unit 12670 (e.g. recorder/reader), a modulation/demodulation unit 12660 (e.g., modulator/demodulator), and a sound processor 12650 are connected to a central controller 12710 via a synchronization bus 12730.

If a user operates a power button to set the mobile phone 12500 from a ‘power off’ state to a power on’ state, the power supply circuit 12700 supplies power to all the parts of the mobile phone 12500 from a battery pack, thereby setting the mobile phone 12500 in an operation mode.

The central controller 12710 includes a central processing unit (CPU), a ROM, and a random access memory (RAM).

While the mobile phone 12500 transmits communication data to the outside, a digital signal is generated in the mobile phone 12500 under control of the central controller. For example, the sound processor 12650 may generate a digital sound signal, the image encoding unit 12720 may generate a digital image signal, and text data of a message may be generated via the operation panel 12540 and the operation input controller 12640. When a digital signal is delivered to the modulation/demodulation unit 12660 under control of the central controller 12710, the modulation/demodulation unit 12660 modulates a frequency band of the digital signal, and a communication circuit 12610 performs digital-to-analog conversion (DAC) and frequency conversion on the frequency band-modulated digital sound signal. A transmission signal output from the communication circuit 12610 may be transmitted to a voice communication base station or the wireless base station 12000 via the antenna 12510.

For example, when the mobile phone 12500 is in a conversation mode, a sound signal obtained via the microphone 12550 is transformed into a digital sound signal by the sound processor 12650, under control of the central controller 12710. The digital sound signal may be transformed into a transformation signal via the modulation/demodulation unit 12660 and the communication circuit 12610, and may be transmitted via the antenna 12510.

When a message, e.g., text message, email, etc., is transmitted in a data communication mode, text data of the text message is input via the operation panel 12540 and is transmitted to the central controller 12610 via the operation input controller 12640. Under control of the central controller 12610, the text data is transformed into a transmission signal via the modulation/demodulation unit 12660 and the communication circuit 12610 and is transmitted to the wireless base station 12000 via the antenna 12510.

To transmit image data in the data communication mode, image data captured by the camera 12530 is provided to the image encoding unit 12720 via the camera interface 12630. The captured image data may be directly displayed on the display screen 12520 via the camera interface 12630 and the LCD controller 12620.

A structure of the image encoding unit 12720 may correspond to a structure of the video encoding apparatus 100 described above. The image encoding unit 12720 may transform the image data received from the camera 12530 into compressed and encoded image data according to the video encoding method described above, and then output the encoded image data to the multiplexer/demultiplexer 12680. During a recording operation of the camera 12530, a sound signal obtained by the microphone 12550 of the mobile phone 12500 may be transformed into digital sound data via the sound processor 12650, and the digital sound data may be delivered to the multiplexer/demultiplexer 12680.

The multiplexer/demultiplexer 12680 multiplexes the encoded image data received from the image encoding unit 12720, together with the sound data received from the sound processor 12650. A result of multiplexing the data may be transformed into a transmission signal via the modulation/demodulation unit 12660 and the communication circuit 12610, and may then be transmitted via the antenna 12510.

While the mobile phone 12500 receives communication data from the outside, frequency recovery and ADC are performed on a signal received via the antenna 12510 to transform the signal into a digital signal. The modulation/demodulation unit 12660 modulates a frequency band of the digital signal. The frequency-band modulated digital signal is transmitted to the video decoding unit 12690, the sound processor 12650, or the LCD controller 12620, according to the type of the digital signal.

In the conversation mode, the mobile phone 12500 amplifies a signal received via the antenna 12510, and obtains a digital sound signal by performing frequency conversion and ADC on the amplified signal. A received digital sound signal is transformed into an analog sound signal via the modulation/demodulation unit 1266 and the sound processor 12650, and the analog sound signal is output via the speaker 12580, under control of the central controller 12710.

When in the data communication mode, data of a video file accessed at an Internet website is received, a signal received from wireless base station 12000 via the antenna 12510 is output as multiplexed data via the modulation/demodulation unit 12660, and the multiplexed data is transmitted to the multiplexer/demultiplexer 12680.

To decode the multiplexed data received via the antenna 12510, the multiplexer/demultiplexer 12680 demultiplexes the multiplexed data into an encoded video data stream and an encoded audio data stream. Via the synchronization bus 12730, the encoded video data stream and the encoded audio data stream are provided to the video decoding unit 12690 and the sound processor 12650, respectively.

A structure of the image decoding unit 12690 may correspond to a structure of the video decoding apparatus 200 described above. The image decoding unit 12690 may decode the encoded video data to obtain restored video data and provide the restored video data to the display screen 12520 via the LCD controller 12602, according to the video decoding method described above.

Thus, the data of the video file accessed at the Internet website may be displayed on the display screen 12520. At the same time, the sound processor 1265 may transform audio data into an analog sound signal, and provide the analog sound signal to the speaker 12580. Thus, audio data contained in the video file accessed at the Internet website may also be reproduced via the speaker 12580.

The mobile phone 12500 or another type of communication terminal may be a transceiving terminal including both a video encoding apparatus and a video decoding apparatus according to exemplary embodiments, may be a transceiving terminal including only the video encoding apparatus according to exemplary embodiments, or may be a transceiving terminal including only the video decoding apparatus according to exemplary embodiments.

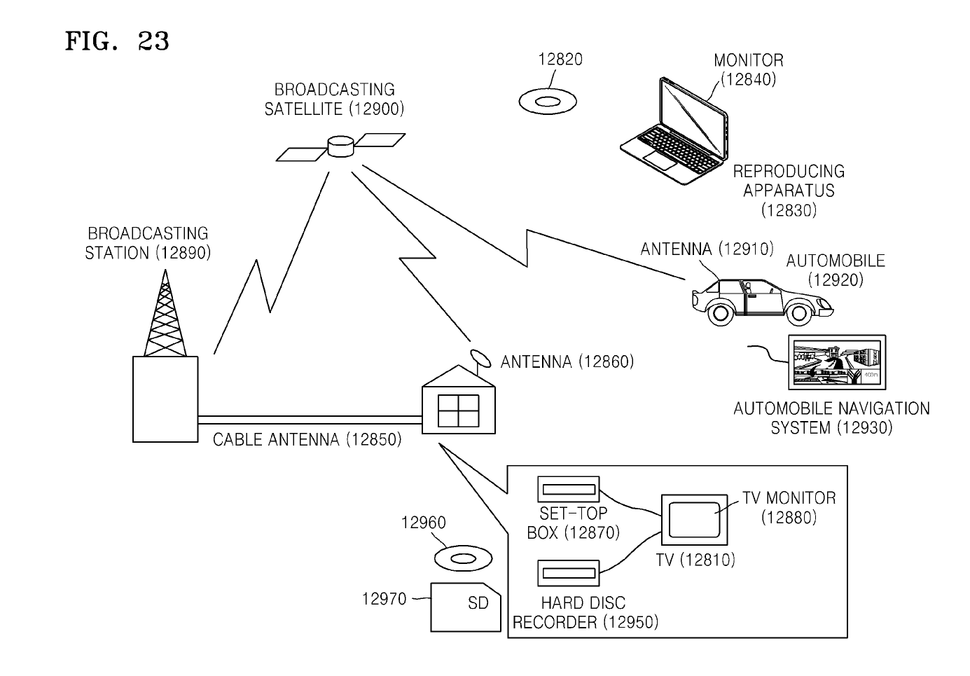

A communication system according to the exemplary embodiments is not limited to the communication system described above with reference to FIG. 20. For example, FIG. 23 illustrates a digital broadcasting system employing a communication system, according to an exemplary embodiment. The digital broadcasting system of FIG. 23 may receive a digital broadcast transmitted via a satellite or a terrestrial network by using a video encoding apparatus and a video decoding apparatus according to exemplary embodiments.

Specifically, a broadcasting station 12890 transmits a video data stream to a communication satellite or a broadcasting satellite 12900 by using radio waves. The broadcasting satellite 12900 transmits a broadcast signal, and the broadcast signal is transmitted to a satellite broadcast receiver via a household antenna 12860. In every house, an encoded video stream may be decoded and reproduced by a TV receiver 12810, a set-top box 12870, or another device.

When a video decoding apparatus according to exemplary embodiments is implemented in a reproducing apparatus 12830, the reproducing apparatus 12830 may parse and decode an encoded video stream recorded on a storage medium 12820, such as a disc or a memory card to restore digital signals. Thus, the restored video signal may be reproduced, for example, on a monitor 12840.

In the set-top box 12870 connected to the antenna 12860 for a satellite/terrestrial broadcast or a cable antenna 12850 for receiving a cable television (TV) broadcast, a video decoding apparatus according to exemplary embodiments may be installed. Data output from the set-top box 12870 may also be reproduced on a TV monitor 12880.

As another example, a video decoding apparatus according to exemplary embodiments may be installed in the TV receiver 12810 instead of the set-top box 12870.

An automobile 12920 including an appropriate antenna 12910 may receive a signal transmitted from the satellite 12900 or the wireless base station 11700. A decoded video may be reproduced on a display screen of an automobile navigation system 12930 built into the automobile 12920.

A video signal may be encoded by a video encoding apparatus according to exemplary embodiments and may then be stored in a storage medium. Specifically, an image signal may be stored in a DVD disc 12960 by a DVD recorder or may be stored in a hard disc by a hard disc recorder 12950. As another example, the video signal may be stored in an SD card 12970. If the hard disc recorder 12950 includes a video decoding apparatus according to exemplary embodiments, a video signal recorded on the DVD disc 12960, the SD card 12970, or another storage medium may be reproduced on the TV monitor 12880.

The automobile navigation system 12930 may not include the camera 12530, the camera interface 12630, and the image encoding unit 12720 of FIG. 20. For example, the computer 12100 and the TV receiver 12810 may not be included in the camera 12530, the camera interface 12630, or the image encoding unit 12720 of FIG. 20.

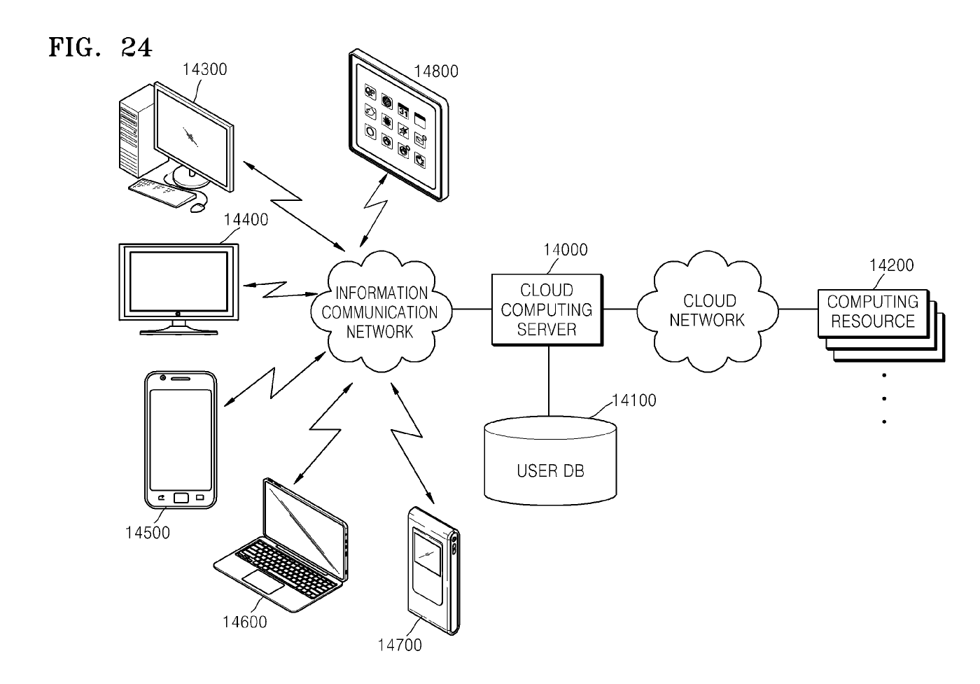

FIG. 24 illustrates a network structure of a cloud computing system using a video encoding apparatus and a video decoding apparatus, according to an exemplary embodiment.

The cloud computing system may include a cloud computing server 14000, a user database (DB) 14100, a plurality of computing resources 14200, and a user terminal.

The cloud computing system provides an on-demand outsourcing service of the plurality of computing resources 14200 via a data communication network, e.g., the Internet, in response to a request from the user terminal. Under a cloud computing environment, a service provider provides users with desired services by combining computing resources at data centers located at physically different locations by using virtualization technology. A service user does not have to install computing resources, e.g., an application, storage, an operating system (OS), and security, in his or her own terminal in order to use the computing resources, but may select and use desired services from among services in a virtual space generated through the virtualization technology, at a desired point of time.

A user terminal of a specified service user is connected to the cloud computing server 14100 via a data communication network including the Internet and a mobile telecommunication network. User terminals may be provided with cloud computing services, and particularly video reproduction services, from the cloud computing server 14100. The user terminals may be various types of electronic devices capable of being connected to the Internet, e.g., a desk-top PC 14300, a smart TV 14400, a smart phone 14500, a notebook computer 14600, a portable multimedia player (PMP) 14700, a tablet PC 14800, and the like.

The cloud computing server 14000 may combine the plurality of computing resources 14200 distributed in a cloud network and provide user terminals with a result of the combining. The plurality of computing resources 14200 may include various data services, and may include data uploaded from user terminals. As described above, the cloud computing server 14000 may provide user terminals with desired services by combining video databases distributed in different regions according to the virtualization technology.

User information about users who have subscribed to a cloud computing service is stored in the user DB 14100. The user information may include login information, addresses, names, and personal credit information of the users. The user information may further include indexes of videos. Here, the indexes may include a list of videos that have already been reproduced, a list of videos that are being reproduced, a pausing point of a video that was being reproduced, and the like.

Information about a video stored in the user DB 14100 may be shared between user devices. For example, when a video service is provided to the notebook computer 14600 in response to a request from the notebook computer 14600, a reproduction history of the video service is stored in the user DB 14100. When a request to reproduce the video service is received from the smart phone 14500, the cloud computing server 14000 searches for and reproduces the video service, based on the user DB 14100. When the smart phone 14500 receives a video data stream from the cloud computing server 14000, a process of reproducing video by decoding the video data stream is similar to an operation of the mobile phone 12500 described above with reference to FIG. 20.

The cloud computing server 14000 may refer to a reproduction history of a desired video service, stored in the user DB 14100. For example, the cloud computing server 14000 may receive a request to reproduce a video stored in the user DB 14100, from a user terminal. If the video was being reproduced, then a method of streaming the video, performed by the cloud computing server 14000, may vary according to the request from the user terminal, e.g., according to whether the video will be reproduced, starting from a start thereof or a pausing point thereof. For example, if the user terminal requests to reproduce the video, starting from the start thereof, the cloud computing server 14000 transmits streaming data of the video starting from a first frame thereof to the user terminal. If the user terminal requests to reproduce the video, starting from the pausing point thereof, the cloud computing server 14000 transmits streaming data of the video starting from a frame corresponding to the pausing point, to the user terminal.

In this case, the user terminal may include a video decoding apparatus as described above with reference to FIGS. 1 through 17. As another example, the user terminal may include a video encoding apparatus as described above with reference to FIGS. 1 through 23. Alternatively, the user terminal may include both the video decoding apparatus and the video encoding apparatus as described above with reference to FIGS. 1 through 17.

Various applications of a video encoding method, a video decoding method, a video encoding apparatus, and a video decoding apparatus according to exemplary embodiments described above with reference to FIGS. 1 through 17 have been described above with reference to FIGS. 18 through 24. However, methods of storing the video encoding method and the video decoding method in a storage medium or methods of implementing the video encoding apparatus and the video decoding apparatus in a device according to various exemplary embodiments described above with reference to FIGS. 1 through 17 are not limited to the exemplary embodiments described above with reference to FIGS. 18 through 24.

The exemplary embodiments may be written as computer programs and may be implemented in general-use digital computers that execute the programs using a computer readable recording medium. Examples of the computer readable recording medium include magnetic storage media (e.g., ROM, floppy disks, hard disks, etc.) and optical recording media (e.g., CD-ROMs, or DVDs).

While certain exemplary embodiments have been particularly shown and described with reference to exemplary embodiments thereof, it will be understood by those of ordinary skill in the art that various changes in form and details may be made therein without departing from the spirit and scope according to the exemplary embodiments as defined by the following claims.

1. A 3-dimensional (3D) video encoding method comprising:
determining whether a current slice is a depth image from among a texture image and the depth image, the texture image and the depth image being part of a 3D image of a same view and being encoded prior to the current slice;
when the determining indicates that the current slice is the depth image, determining whether to encode the depth image by using the texture image;
when the determining indicates that the current slice is the texture image, determining whether to encode the texture image by using the depth image; and
encoding the texture image and the depth image based on a relationship between the texture image and the depth image, the relationship being determined based on the determining of whether to encode the depth image by using the texture image and the determining of whether to encode the texture image by using the depth image.

2. The 3D video encoding method of claim 1, wherein the encoding comprises: when the current slice is the depth image, encoding the depth image by using the texture image,
the 3D video encoding method further comprising: generating a slice header comprising first information indicating that the current slice is the depth image and second information indicating that the depth image is encoded by using the texture image.

3. The 3D video encoding method of claim 1, wherein the encoding comprises: when the current slice is the texture image, encoding the texture image by using the depth image,
the 3D video encoding method further comprising: generating a slice header comprising first information indicating that the current slice is not the depth image and third information indicating that the texture image is encoded by using the depth image.

4. The 3D video encoding method of claim 2, wherein, when the current slice is the depth image, the determining of whether to encode the depth image comprises: determining whether to determine slice related information of the depth image by referring to slice related information of the texture image,
wherein the encoding comprises: encoding the depth image by using the slice related information of the texture image, and
wherein the generating of the slice header comprises: when the current slice is the depth image, generating the slice header further comprising fourth information indicating whether to determine the slice related information of the depth image by referring to the slice related information of the texture image.

5. The 3D video encoding method of claim 4, wherein the generating of the slice header further comprises: if the fourth information indicates that the slice related information of the texture image is not referred to when determining the slice related information of the depth image, generating the slice header to further comprise at least one among information indicating a decoded picture buffer (DPB) state of a reference picture selection (RPS) of the depth image, a reference index, and a slice quantization parameter (QP) differential value.

6. The 3D video encoding method of claim 1, wherein the encoding comprises: among maximum coding units spatially split from the texture image and the depth image, splitting each of the maximum coding units into a plurality of coding units, and determining whether to split each of the plurality of coding units into smaller coding units independently from adjacent coding units among the plurality of coding units; and
outputting encoding information that is determined from a coding unit that is no longer split among the plurality of coding units.

7. A 3D video decoding method comprising:
determining whether a current slice is a depth image from among a texture image and the depth image, the texture image and the depth image being part of a 3D image of a same view and being encoded prior to the current slice;
when the determining indicates that the current slice is the depth image, determining whether to decode the depth image by using the texture image;
when the determining indicates that the current slice is the texture image, determining whether to decode the texture image by using the depth image; and
decoding the texture image and the depth image based on a relationship between the texture image and the depth image, the relationship being determined based on the determining of whether to decode the depth image by using the texture image and the determining of whether to decode the texture image by using the depth image.

8. The 3D video decoding method of claim 7, further comprising: parsing first information indicating that the current slice is the depth image and second information indicating that the depth image is decoded by using the texture image from a slice header for the current slice,
wherein the decoding comprises: when the current slice is read as the depth image based on the first information, decoding the depth image by using the texture image.

9. The 3D video decoding method of claim 7, further comprising: parsing first information indicating that the current slice is not the depth image and third information indicating that the texture image is decoded by using the depth image,
wherein the decoding comprises: when the current slice is read as the texture image, decoding the texture image by using the depth image.

10. The 3D video decoding method of claim 8, wherein, when the current slice is read as the depth image based on the first information, the parsing of the second information comprises: parsing fourth information indicating whether to determine slice related information of the depth image by referring to slice related information of the texture image from the slice header,
wherein the determining of whether to decode the depth image comprises: determining whether to determine the slice related information of the depth image by referring to the slice related information of the texture image based on the fourth information, and
wherein the decoding comprises: decoding the depth image by using the slice related information of the texture image according to a determination based on the fourth information.

11. The 3D video decoding method of claim 10, wherein the decoding further comprises: if the fourth information indicates that the slice related information of the texture image is not referred to when determining the slice related information of the depth image, parsing further at least one among information indicating a decoded picture buffer (DPB) state of a reference picture selection (RPS) of the depth image, a reference index, and a slice quantization parameter (QP) differential value from the slice header.

12. The 3D video decoding method of claim 7, wherein the decoding comprises: among maximum coding units spatially split from the texture image and the depth image, splitting each of the maximum coding units into a plurality of coding units, and determining whether to split each of the plurality of coding units into smaller coding units independently from adjacent coding units among the plurality of coding units; and
decoding a coding unit that is no longer split among the plurality of coding units by using encoding information that is determined from the coding unit.

13. A 3D video encoding apparatus comprising:
a 3D image reference determiner configured to determine whether a current slice is a depth image from among a texture image and the depth image, the texture image and the depth image being part of a 3D image of a same view and being encoded prior to the current slice, wherein, when the 3D image reference determiner determines that the current slice is the depth image, the 3D image reference determiner is further configured to determine whether to encode the depth image by using the texture image, and, when the 3D image reference determiner determines that the current slice is the texture image, the 3D image reference determiner is further configured to determine whether to encode the texture image by using the depth image; and
an encoder configured to encode the texture image and the depth image based on a relationship between the texture image and depth image, the relationship being determined based on the determination of whether to encode the depth image by using the texture image and the determination of whether to encode the texture image by using the depth image.

14. A 3D video decoding apparatus comprising:
a 3D image reference parser configured to determine whether a current slice is a depth image from among a texture image and the depth image, the texture image and the depth image being part of a 3D image of a same view and being encoded prior to the current slice, from information parsed from a slice header, wherein, when the 3D image reference parser determines that the current slice is the depth image, the 3D image reference parser is further configured to determine whether to decode the depth image by using the texture image, and, when the 3D image reference parser determines that the current slice is the texture image, the 3D image reference parser is further configured to determine whether to decode the texture image by using the depth image; and
a decoder configured to decode the texture image and the depth image based on a relationship between the texture image and depth image, the relationship being determined based on the determination of whether to decode the depth image by using the texture image and the determination of whether to decode the texture image by using the depth image.

15. A non-transitory computer readable recording medium having recorded thereon a program for executing the 3D video encoding method of claim 1.

16. A non-transitory computer readable recording medium having recorded thereon a program for executing the 3D video decoding method of claim 7.
